(19) United States
(12) Patent Application Publication
(10) Pub. No.: US 2011/0134327 A1
(43) Pub. Date: Jun. 9, 2011

(54) DIGITAL BROADCAST RECEIVER

(76) Inventors: Kazuma Kaneko, Tokyo (JP); Nobuyoshi Okumura, Tokyo (JP); Yoshio Todoroki, Tokyo (JP)

(21) Appl. No.: 13/058,499

(22) PCT Filed: Sep. 30, 2009
(86) PCT No.: PCT/JP2009/005040

§ 371 Date: Feb. 10, 2011

(30) Foreign Application Priority Data
Oct. 16, 2008 (JP) 2008-267457

(51) Int. Cl. H04N 5/445

(52) U.S. Cl. 348/569; 348/E05.099

(57) ABSTRACT

A digital broadcast receiver includes a broadcast reception and reproduction unit 1 for reproducing a program video image included in a received broadcast, a broadcast information collection unit 14 for collecting broadcast information included in the received broadcast in parallel with the reproduction of the program video image by the broadcast reception and reproduction unit, a collection status generation unit 19 for generating a collection status of the broadcast information collected by the broadcast information collection unit 14, and an output control unit 7 for displaying both the program video image reproduced by the broadcast reception and reproduction unit and the collection status of the broadcast information generated by the collection status generation unit.

### FIELD OF THE INVENTION

The present invention relates to a digital broadcast receiver that receives a digital broadcast. More particularly, it relates to a technology of displaying the status of acquisition of broadcast information in parallel with a display of a broadcast program.

### BACKGROUND OF THE INVENTION

As a technology of receiving a plurality of broadcasts, patent reference 1 discloses a television receiver equipped with a child screen display function of enabling the user to browse the broadcast contents of each channel on a child screen, and, when the user desires to watch a channel after watching another channel, enabling the user to easily switch to the channel. This television receiver is provided with two tuners, two signal processing circuits, a child screen formation circuit for forming one reduced moving image and one or more reduced still images, a parent screen formation circuit, a display circuit for compositing the output of the child screen formation circuit and that of the parent screen formation circuit into a composite image to display this composite image, a control unit for controlling a channel selection by each of the two tuners and the child screen formation circuit, and an operation unit which is operated by a user. While the user watches a program, the television receiver receives other programs provided by the other stations in turn, and displays a plurality of child screens to show the other programs. Accordingly, the user can select a desired station while watching a program video image provided by each station.

Furthermore, patent reference 2 discloses a television receiver that can efficiently capture both accumulative attached data and real-time attached data. In this television receiver, a decoder decodes either the accumulative attached data or the real-time attached data. A decode management information storage unit stores information for causing the decoder to determine whether to give a higher priority to the decoding of the accumulative attached data or the decoding of the real-time attached data. A control unit controls switching by using a signal switching unit according to the information. When decoding the accumulative attached data, the signal switching unit inputs the output of a tuner that is not displayed on a display unit to the decoder, whereas when decoding the real-time attached data, the signal switching unit inputs the output of a tuner that is displayed on the display unit to the decoder. As a result, the television receiver can display a list of programs provided by other stations together with a program video image currently being watched.

### RELATED ART DOCUMENT

### Patent Reference

Patent reference 1: JP,7-107410,A
Patent reference 2: JP,11-46353,A

### SUMMARY OF THE INVENTION

A problem with the technologies disclosed by above-mentioned patent references 1 and 2 is that because either a program video image provided by another station or broadcast information, such as a program list, is displayed simultaneously with a program video image currently being watched, the program video image currently being watched is displayed while being reduced greatly in size, and therefore the visibility of the program video image is impaired. Particularly, when these television receivers are used as vehicle-mounted equipment, the visibility of the program video image is impaired greatly because the screen size of a vehicle-mounted display is small and its resolution is low.

Furthermore, the use of the technology disclosed by patent reference 2 makes it possible to display broadcast information which is collected in advance by using a tuner disposed independently from that used for watching in an instant, though it takes much time to display the broadcast information when the broadcast information is being acquired or when the broadcast information has not been acquired. As a result, because the user has to wait for a display of the broadcast information in a state in which he or she cannot know whether or not the broadcast information has been collected, a problem is that the user feels burdensome to wait for a display of the broadcast information.

The present invention is made in order to solve the above-mentioned problems, and it is therefore an object of the present invention to provide a digital broadcast receiver that enables a user to easily grasp whether the digital broadcast receiver has completed the collection of broadcast information while ensuring the visibility of a program video image.

In order to solve the above-mentioned problems, a digital broadcast receiver in accordance with the present invention includes: a broadcast reception and reproduction unit for reproducing a program video image included in a received broadcast; a broadcast information collection unit for collecting broadcast information included in the received broadcast in parallel with the reproduction of the program video image by the broadcast reception and reproduction unit; a collection status generation unit for generating a collection status of the broadcast information collected by the broadcast information collection unit; and an output control unit for displaying both the program video image reproduced by the broadcast reception and reproduction unit and the collection status of the broadcast information generated by the collection status generation unit.

Because the digital broadcast receiver in accordance with the present invention displays the collection status of the broadcast information, as well as the program video image currently being watched, on the screen, the digital broadcast receiver enables the user to easily grasp whether the digital broadcast receiver has completed the collection of broadcast information while ensuring the visibility of the program video image. For example, the digital broadcast receiver can reduce the frequency with which the user feels burdensome to wait for a display of a program list after commanding the digital broadcast receiver to display the program list.

### BRIEF DESCRIPTION OF THE FIGURES

FIG. 1 is a block diagram showing the functional structure of a digital broadcast receiver in accordance with Embodiment 1 of the present invention;

FIG. 2 is a flow chart showing the operation of the digital broadcast receiver in accordance with Embodiment 1 of the present invention;

FIG. 3 is a view showing an example of a conceptual screen display which is outputted by the digital broadcast receiver in accordance with the Embodiment 1 of the present invention;

FIG. 4 is a view showing another example of the conceptual screen display which is outputted by the digital broadcast receiver in accordance with the Embodiment 1 of the present invention;

FIG. 5 is a view showing a further example of the conceptual screen display which is outputted by the digital broadcast receiver in accordance with the Embodiment 1 of the present invention;

FIG. 6 is a flow chart showing the operation of a digital broadcast receiver in accordance with Embodiment 2 of the present invention;

FIG. 7 is a view showing an example of a conceptual screen display which is outputted by the digital broadcast receiver in accordance with Embodiment 2 of the present invention;

FIG. 8 is a view showing another example of the conceptual screen display which is outputted by the digital broadcast receiver in accordance with Embodiment 2 of the present invention;

FIG. 9 is a flow chart showing the operation of a digital broadcast receiver in accordance with Embodiment 3 of the present invention;

FIG. 10 is a view showing an example of a conceptual screen display which is outputted by the digital broadcast receiver in accordance with Embodiment 3 of the present invention;

FIG. 11 is a flow chart showing the operation of a digital broadcast receiver in accordance with Embodiment 4 of the present invention;

FIG. 12 is a view showing an example of a conceptual screen display which is outputted by the digital broadcast receiver in accordance with Embodiment 4 of the present invention;

FIG. 13 is a view showing another example of the conceptual screen display which is outputted by the digital broadcast receiver in accordance with Embodiment 4 of the present invention;

FIG. 14 is a view showing a further example of the conceptual screen display which is outputted by the digital broadcast receiver in accordance with Embodiment 4 of the present invention;

FIG. 15 is a view showing an example of a conceptual screen display which is outputted by a digital broadcast receiver in accordance with Embodiment 5 of the present invention;

FIG. 16 is a view showing another example of the conceptual screen display which is outputted by the digital broadcast receiver in accordance with Embodiment 5 of the present invention;

FIG. 17 is a view showing a further example of the conceptual screen display which is outputted by the digital broadcast receiver in accordance with Embodiment 5 of the present invention;

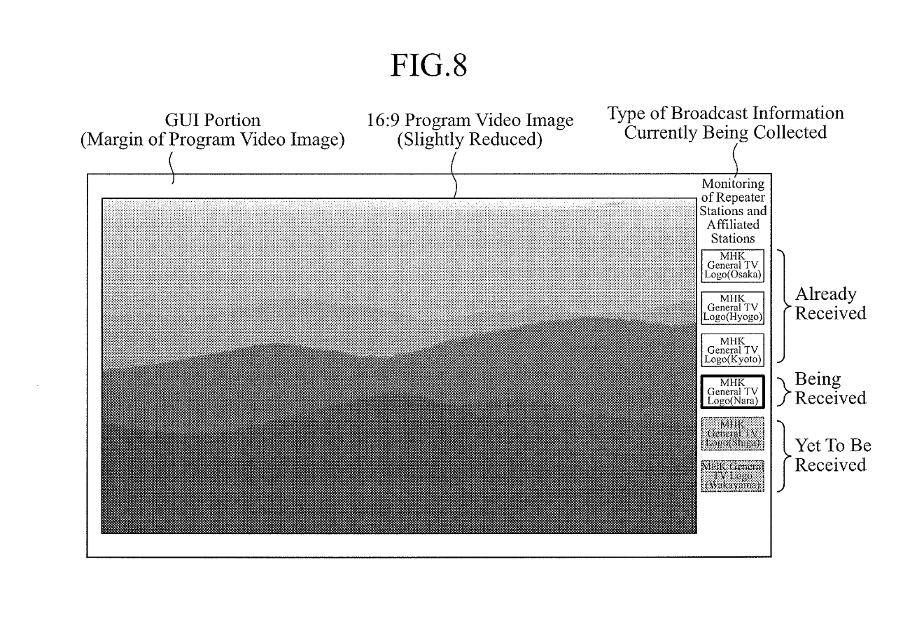

FIG. 8 is a view showing an example of a conceptual screen display which is outputted by a digital broadcast receiver in accordance with Embodiment 6 of the present invention;

FIG. 19 is a view showing an example of a table for use with the digital broadcast receiver in accordance with Embodiment 6 of the present invention;

FIG. 20 is a view showing an example of a conceptual screen display which is outputted by a digital broadcast receiver in accordance with Embodiment 7 of the present invention;

FIG. 21 is a view showing another example of the conceptual screen display which is outputted by the digital broadcast receiver in accordance with Embodiment 7 of the present invention;

FIG. 22 is a view showing a further example of the conceptual screen display which is outputted by the digital broadcast receiver in accordance with Embodiment 7 of the present invention;

FIG. 23 is a view showing an example of a conceptual screen display which is outputted by a digital broadcast receiver in accordance with Embodiment 8 of the present invention;

FIG. 24 is a view showing another example of the conceptual screen display which is outputted by the digital broadcast receiver in accordance with Embodiment 8 of the present invention;

FIG. 25 is a view showing an example of a conceptual screen display which is outputted by a digital broadcast receiver in accordance with Embodiment 9 of the present invention;

FIG. 26 is a view showing another example of the conceptual screen display which is outputted by the digital broadcast receiver in accordance with Embodiment 9 of the present invention;

FIG. 27 is a view showing a further example of the conceptual screen display which is outputted by the digital broadcast receiver in accordance with Embodiment 9 of the present invention;

FIG. 28 is a flow chart showing the operation of a digital broadcast receiver in accordance with Embodiment 10 of the present invention;

FIG. 29 is a view showing an example of a conceptual screen display which is outputted by the digital broadcast receiver in accordance with Embodiment 10 of the present invention;

FIG. 30 is a view showing another example of the conceptual screen display which is outputted by the digital broadcast receiver in accordance with Embodiment 10 of the present invention; and

FIG. 31 is a block diagram showing the functional structure of a digital broadcast receiver in accordance with Embodiment 11 of the present invention.

### EMBODIMENTS OF THE INVENTION

Hereafter, in order to explain this invention in greater detail, the preferred embodiments of the present invention will be described with reference to the accompanying drawings.

### Embodiment 1

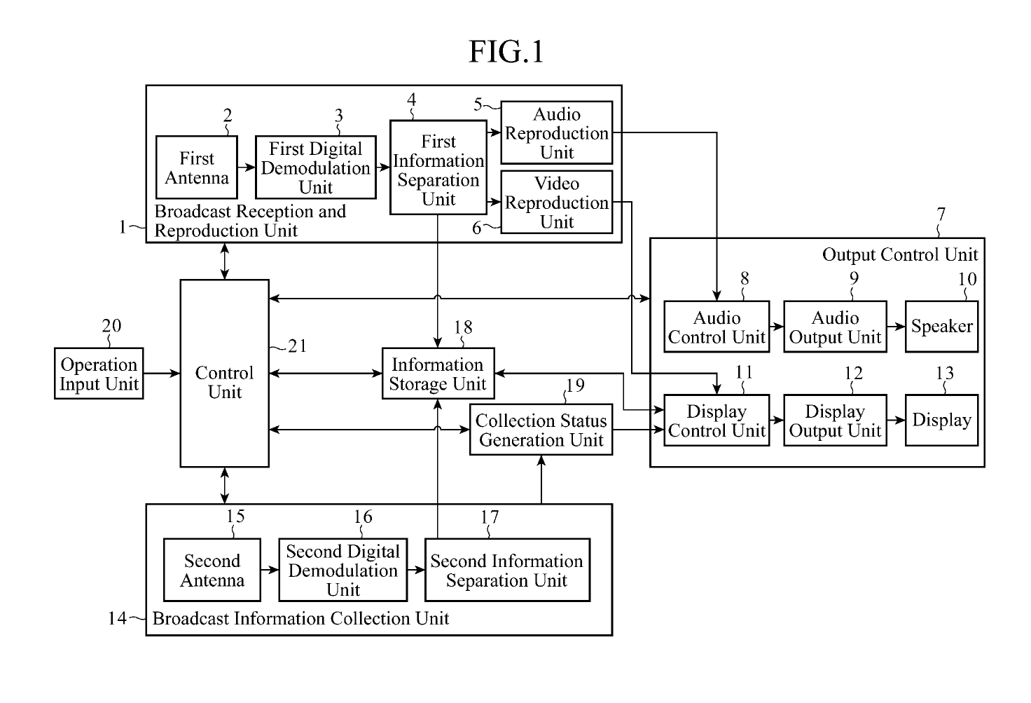

FIG. 1 is a block diagram showing the functional structure of a digital broadcast receiver in accordance with Embodiment 1 of the present invention. This digital broadcast receiver has the same hardware as that of digital television receivers for home use, and hardware for implementing the function of each block will be explained one after the other hereafter.

This digital broadcast receiver is provided with a broadcast reception and reproduction unit 1, an output control unit 7, a broadcast information collection unit 14, an information storage unit 18, a collection status generation unit 19, an operation input unit 20, and a control unit 21. From the viewpoint of hardware implementation, the broadcast reception and reproduction unit 1 is comprised of a receiving circuit for receiving a radio wave, a tuner, a large-scale integration circuit for digital demodulation, a large-scale integration circuit for MPEG (Moving Picture Experts Group) processing or a video and audio

processing circuit (all of them are not shown in the figure), and so on, and receives a digital broadcast.

From the viewpoint of functions, this broadcast reception and reproduction unit 1 is provided with a first antenna 2, a first digital demodulation unit 3, a first information demultiplex unit 4, an audio reproduction unit 5, and a video reproduction unit 6. The first antenna 2 receives digital terrestrial television broadcast waves broadcast via channels 13 to 62 in a UHF (Ultra High Frequency) band, and converts them into electric signals and sends these electric signals to the first digital demodulation unit 3 as received signals.

The first digital demodulation unit 3 selects a desired channel of a broadcast wave, performs digital demodulation on the digital-modulated received signal which is sent thereto from the first antenna 2 to create a transport stream (referred to as “TS: Transport Stream” from here on), and sends this TS to the first information demultiplex unit 4. A TS is based on the MPEG-2 standards and the ARIB (Association of Radio Industries and Businesses) standards, and is comprised of a data sequence in which a video image, an audio, program information, etc. are multiplexed. Above-mentioned ARIB is a registered trademark.

The first information demultiplex unit 4 analyzes various pieces of broadcast information which are multiplexed into the TS sent from the first digital demodulation unit 3 so as to separate the various pieces of broadcast information from the TS. The various pieces of broadcast information separated by this first information demultiplex unit 4 are sent to the information storage unit 18, digital audio information separated by the first information demultiplex unit is sent to the audio reproduction unit 5, and digital image information separated by the first information demultiplex unit is sent to the video reproduction unit 6.

The audio reproduction unit 5 analyzes the digital audio information sent thereto from the first information demultiplex unit 4, decodes this digital audio information by using a method suitable for this digital audio information, reproduces a digital audio signal, and sends this digital audio signal to an audio control unit 8 of the output control unit 7. A program audio is outputted according to this digital audio signal. The video reproduction unit 6 analyzes the digital image information sent thereto from the first information demultiplex unit 4, decodes this digital image information by using a method suitable for the digital image information, reproduces a digital video signal, and sends this digital video signal to a display control unit 11 of the output control unit 7. A program video image is outputted according to this digital video signal.

From the viewpoint of hardware implementation, the output control unit 7 is comprised of a liquid crystal display or the like (not shown in the figure) including an analog audio output circuit, an analog video output circuit, and a speaker therein, and controls the output of the program video image and that of the program audio. From the viewpoint of functions, this output control unit 7 is provided with the audio control unit 8, an audio output unit 9, a speaker 10, the display control unit 11, a display output unit 12, and a display 13.

The audio control unit 8 controls an output enable or disable, audio volume, etc. of the digital audio signal showing the program audio, the digital audio signal being sent thereto from the audio reproduction unit 5 of the broadcast reception and reproduction unit 1. The digital audio signal the output of which is controlled by this audio control unit 8 is sent to the audio output unit 9. The audio output unit 9 is comprised of a D/A converter, for example, converts the digital audio signal sent thereto from the audio control unit 8 into an analog audio signal, and sends this analog audio signal to the speaker 10. The speaker 10 converts the analog audio signal sent thereto from the audio output unit 9 into an audio, and outputs this audio.

The display control unit 11 controls the superimposition in the program video image shown by the digital video signal sent thereto from the video reproduction unit 6 of the broadcast reception and reproduction unit 1, and the graphics plane of a GUI (Graphical User Interface) screen display such as a data broadcast screen display or a menu. The digital video signal controlled by this display control unit 11 is sent to the display output unit 12. The display output unit 12 is comprised of a D/A converter, for example, converts the digital video signal sent thereto from the display control unit 11 into an analog video signal, and sends this analog video signal to the display 13. The display 13 converts the analog video signal sent thereto from the display output unit 12 into light, and outputs this light.

From the viewpoint of hardware implementation, the broadcast information collection unit 14 is comprised of a receiving circuit for receiving a radio wave, a tuner, a large-scale integration circuit for digital demodulation, and a large-scale integration circuit for MPEG processing, and so on (not illustrated in the figure), like the broadcast reception and reproduction unit 1, and collects broadcast information, such as program information which is included in a broadcast. Although collection of broadcast information is performed on a broadcast being watched also by the broadcast reception and reproduction unit 1, and is carried out mainly by the broadcast information collection unit 14.

From the viewpoint of function implementation, this broadcast information collection unit 14 is provided with a second antenna 15, a second digital demodulation unit 16, and a second information demultiplex unit 17. The second antenna 15 receives a broadcast wave, converts this broadcast wave into an electric signal, and sends this electric signal to the second digital demodulation unit 16 as a received signal. The second digital demodulation unit 16 performs digital demodulation on the received signal sent thereto from the second antenna 15, and sends the received signal demodulated to the second information demultiplex unit 17. The second information demultiplex unit 17 separates broadcast information from the digital-demodulated signal which is sent thereto from the second digital demodulation unit 16, and sends the broadcast information to the information storage unit 18.

The broadcast information collection unit 14 which is constructed as above sequentially receives receivable broadcasts which are detected beforehand through initial scanning or re-scanning, separates and extracts program information which is one piece of broadcast information included in each of the broadcasts, and stores the program information in the information storage unit 18. After storing the program information about all the receivable broadcasting stations, the broadcast information collection unit stops the processing temporarily and does not start the processing until the program information is updated. The program information is information for creating a program list, and there are three different update time interval lengths including 9 hours, two days, and eight days. For example, after acquiring eight days of program information, the broadcast information collection unit does not acquire any program information for eight days.

From the viewpoint of hardware implementation, the information storage unit 18, the collection status generation unit 19, and the control unit 21 which construct the digital broadcast receiver are comprised of a microcomputer, a volatile memory, a nonvolatile memory, a peripheral input/output circuit, and so on (not illustrated in the figure).

The information storage unit 18 stores the broadcast information collected from the first information demultiplex unit 4 of the broadcast reception and reproduction unit 1 and the second information demultiplex unit 17 of the broadcast information collection unit 14. The broadcast information stored in this information storage unit 18 is referred to by the output control unit 7 and the control unit 21. The collection status generation unit 19 generates information showing the collection status of the broadcast information. The information generated by this collection status generation unit 19 is sent to the output control unit 7 and the control unit 21.

The operation input unit 20 is comprised of a remote controller (referred to as a “remote control” from here on), a remote control receiving circuit, and so on, for example, and accepts a user's operation. Operation information which is inputted through the user's operation on this operation input unit 20 is sent to the control unit 21. The control unit 21 controls the whole of this digital broadcast receiver. For example, the control unit 21 controls each unit of the digital broadcast receiver according to the operation information sent thereto from the operation input unit 20, and implements an operation which the user desires, such as channel switching or a display of a data broadcast.

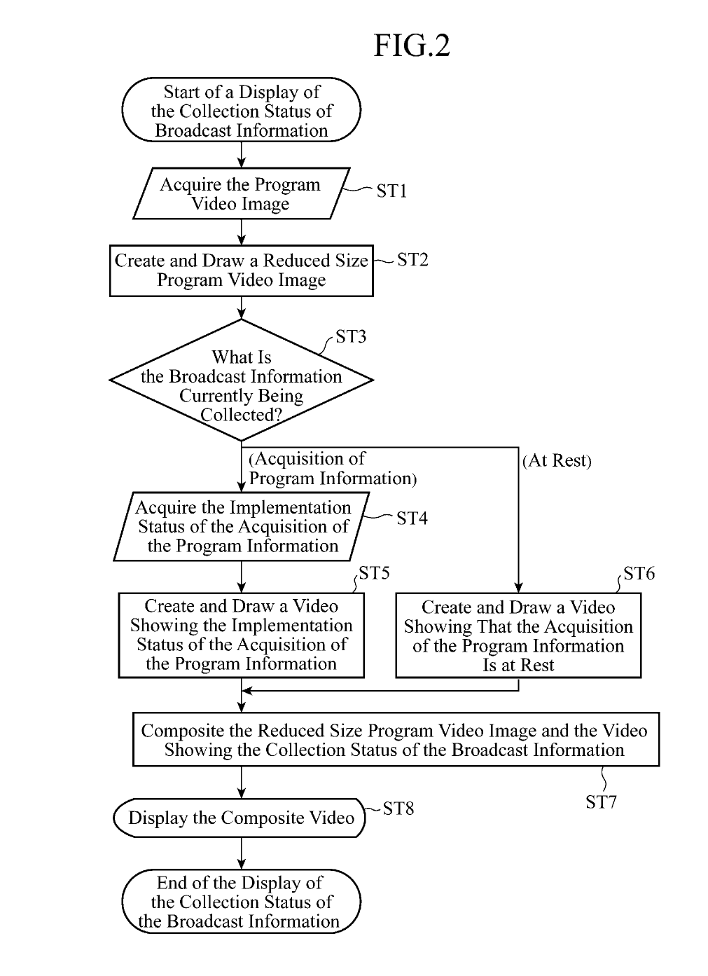

Next, the operation of the digital broadcast receiver in accordance with Embodiment 1 of the present invention which is constructed as above will be explained with reference to a flow chart shown in FIG. 2, focusing on a process of displaying the collection status of the broadcast information.

In the process of displaying the collection status of the broadcast information, a program video image is acquired first (step ST1). More specifically, the display control unit 11 acquires one frame of the program video image currently being reproduced from the video reproduction unit 6. Actually, the display control unit 11 acquires a “digital video signal” corresponding to one frame of the program video image currently being reproduced from the video reproduction unit 6. Although various processes are performed on this digital video signal, descriptions about the processes which are performed on the digital video signal will be omitted hereafter in order to avoid the complicatedness of the explanation.

Then, creation of a reduced size image from the program video image and drawing of the reduced size image are carried out (step ST2). More specifically, the display control unit 11 slightly reduces one frame of the program video image in size to create a reduced size image, and draws this reduced size image in a moving image plane (not illustrated) disposed therein. The reduction ratio of the program video image can be determined properly in such a way that a blank part in which the implementation status of the acquisition of the program information can be displayed can be acquired with respect to the screen size in which the program video image can be displayed.

The broadcast information currently being collected is then checked to see (step ST3). More specifically, the display control unit 11 acquires the broadcast information currently being collected from the collection status generation unit 19, and, when the broadcast information collection unit 14 is acquiring the program information, advances to step ST4, whereas the broadcast information collection unit 14 is at rest after completing the acquisition of the program information, the display control unit 11 advances to step ST6. At fixed time intervals or when the status changes, the collection status generation unit 19 acquires the information from the broadcast information collection unit 14 to always store the collection status of the program information therein.

The implementation status of the acquisition of the program information is acquired in step ST4. More specifically, the display control unit 11 acquires the information about each broadcast station from which the program information has been acquired, the information about each broadcast station from which the program information is being acquired, and the information about each broadcast station from which the program information has not been acquired yet from the collection status generation unit 19 as the implementation status of the acquisition of the program information. Furthermore, for each broadcast station from which the program information is being acquired, the display control unit 11 also acquires a ratio of the acquired program information (a ratio of the acquired data volume to the total data volume). The display control unit 11 can grasp the total data volume of the program information by analyzing an EIT (Event Information Table) with which to transmit the program information. This analyzing method is the same as that for use in a case in which a digital television receiver for home use generates an electronic program guide.

Creation and drawing of an image showing the implementation status of the acquisition of the program information are then carried out (step ST5). More specifically, the display control unit 11 draws the broadcast station logo of each broadcast station from which program information has been acquired at transmittance=0% (untransparent), the broadcast station logo of each broadcast station from which program information is being acquired at transmittance=(1−the ratio of the acquired program information)×100%, and the broadcast station logo of each broadcast station from which program information has not been acquired yet at transmittance=100% (transparent) in an OSD (On Screen Display) plane. As a result, the collection status of the broadcast information is displayed in a non-video image form. The broadcast station logo of each broadcast station is sent out via broadcast from each broadcast station, and the digital broadcast receiver can acquire the broadcast station logo by receiving a CDT (Common Data Table). As a method of acquiring this broadcast station logo, the digital broadcast receiver can use the same method as that used by a digital television receiver for home use. After that, the digital broadcast receiver advances the sequence to step ST7.

In step ST6, creation and drawing of an image showing that the program information acquisition processing is at rest are carried out. More specifically, because having acquired the pieces of program information about all the broadcast stations, the display control unit 11 draws all the broadcast station logos at transmittance=0% (untransparent) in the OSD plane. After that, the digital broadcast receiver advances the sequence to step ST7.

In step ST7, the reduced size program video image and the image showing the collection status of the broadcast information are composited into a composite image. More specifically, the display control unit 11 composites the image in the OSD plane showing the implementation status of the acquisition of the program information, which is generated in step ST5 or ST6, and the image in the moving image plane which is the reduced size image into a composite image. In a digital television receiver, a plurality of drawing planes are prepared for contents to be drawn, such as a program video image, a subtitle and superimposed characters, and a data broadcast, and a television screen display is produced by compositing images respectively drawn in the drawing planes. A drawing method of drawing an image is the same as that for use in a digital television receiver for home use.

The composite image is then displayed (step ST8). More specifically, the display control unit 11 sends the composite image to the display output unit 12, the display output unit 12 converts the composite image into an NTSC (National Television Standards Committee) signal, for example, adjusts the color tone and brightness of the NTSC signal, and sends this NTSC signal to the display 13, and the display 13 displays the composite image according to the NTSC signal. After that, the digital broadcast receiver ends the process of displaying the collection status of the broadcast information.

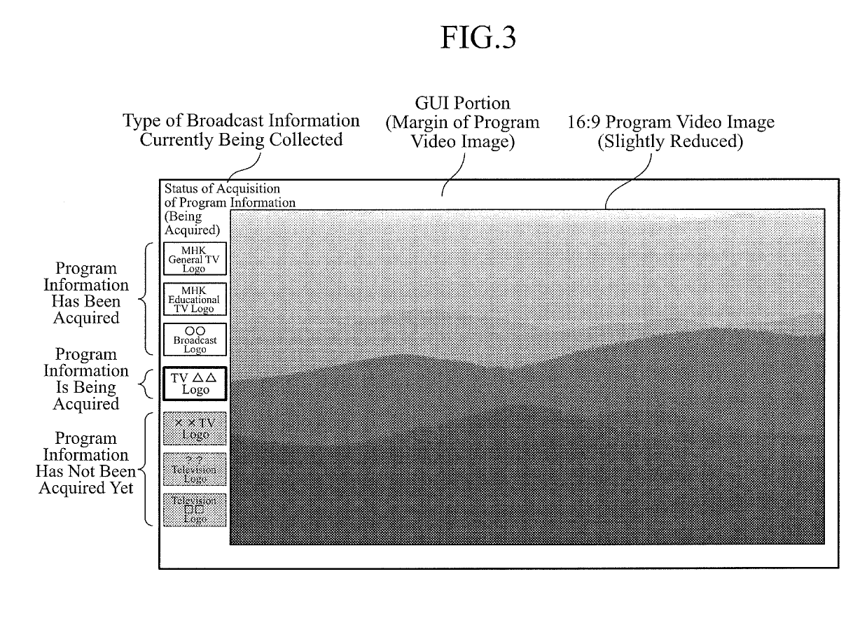

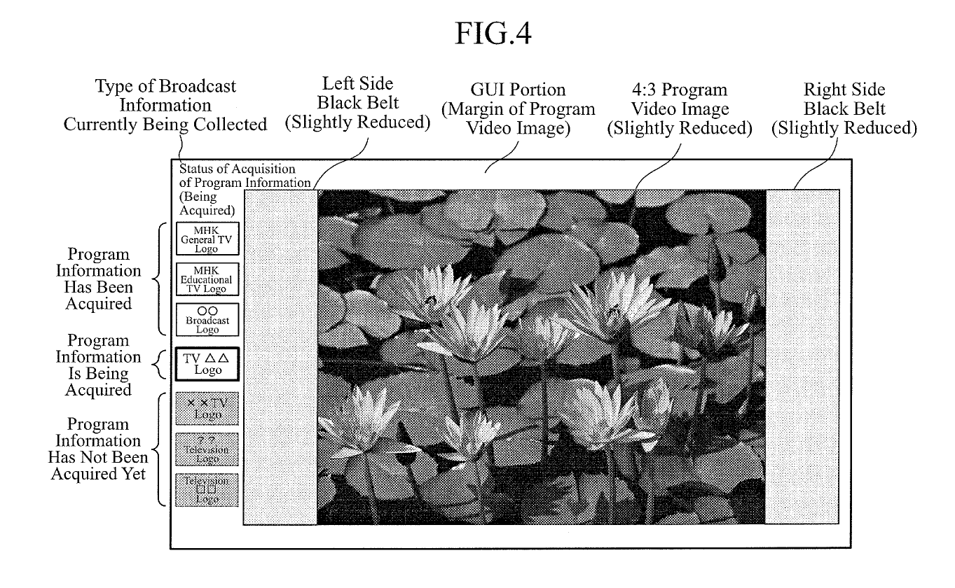

In the above-mentioned process of displaying the collection status of the broadcast information, examples of a conceptual display screen produced in a case in which the digital broadcast receiver goes via steps ST4 and ST5 (when the program information is being acquired) are shown in FIGS. 3 and 4. FIG. 3 shows a conceptual display screen which is produced when the program information is being acquired, and shows an image of mountains which is a slightly-reduced program video image of “16:9”. Squares arranged in a left side margin of the display screen and running in a vertical direction are the logos of broadcast stations respectively, and each of these logos shows the status of the acquisition of the corresponding program information.

FIG. 4 shows a conceptual display screen which is produced when the program information is being acquired, and shows an image of flowers which is a slightly-reduced program video image of “4:3”. Portions on the right and left sides of the program video image are margins which are produced when displaying the program video image at “16:9” (the margins are called black belts because they are typically black-colored in many cases), and a portion on a further left side of the left side black belt is the same as that shown in FIG. 3.

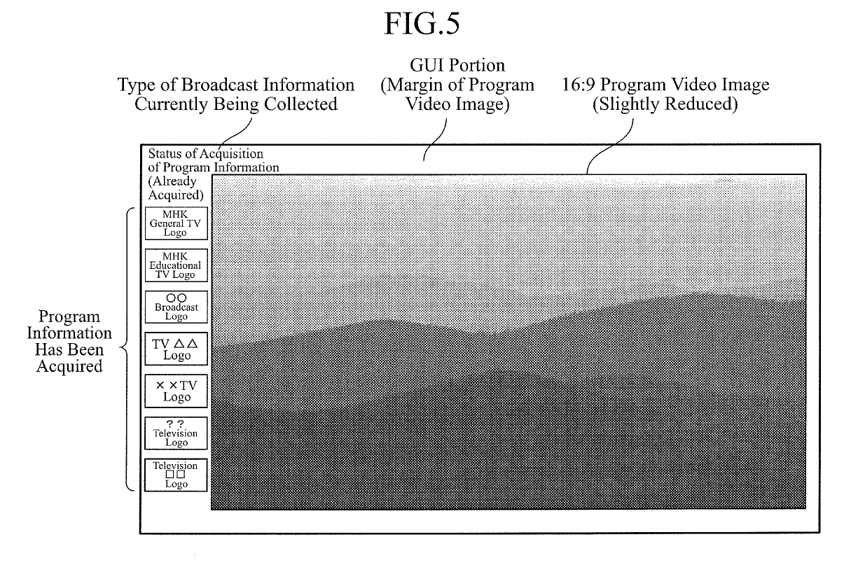

FIG. 5 shows a conceptual display screen which is produced in a case in which the digital broadcast receiver goes via step ST6 in the above-mentioned process, that is, in a case in which the acquisition of the program information is at rest (the acquisition of the program information has been completed), shows an image of mountains which is a slightly-reduced program video image of “16:9”. Squares arranged in a left side margin of the display screen and running in a vertical direction are the logos of broadcast stations respectively, and each of these logos shows the status of the acquisition of the corresponding program information.

In the left side portion of the screen shown in each of above-mentioned FIGS. 3, 4, and 5, the logo of each broadcast station from which the program information has been acquired is displayed normally (untransparent), the logo of each broadcast station from which the program information is being acquired is displayed in a semi-transparent form, and the logo of each broadcast station from which the program information has not been acquired yet is not displayed.

As explained above, because the digital broadcast receiver in accordance with Embodiment 1 of the present invention is constructed in such a way as to display the implementation status of the acquisition of the program information from each broadcast station with the transmittance of the logo of each broadcast station, the user can easily grasp whether the digital broadcast receiver has acquired the program information for each broadcast station. Therefore, because the digital broadcast receiver enables the user to judge whether it takes much time for the digital broadcast receiver to display the program information for each broadcast station before performing a display operation of making the digital broadcast receiver display a program list, the digital broadcast receiver reduces the frequency with which the user feels burdensome to wait for a display of the program information.

Furthermore, because the digital broadcast receiver is constructed in such a way as to display the collection status of the broadcast information at a position where the display of the collection status does not overlap the program video image, the visibility of the program video image is not impaired. In addition, because the digital broadcast receiver is constructed in such a way as to display the collection status of the broadcast information in a blank part formed by reducing the program video image, the digital broadcast receiver can always display the collection status of the broadcast information in the blank part with almost no impairment of the visibility of the program video image.

The digital broadcast receiver in accordance with above-mentioned Embodiment 1 is constructed in such a way as to display the implementation status of the acquisition of the program information from each broadcast station in a vertical direction in a left end portion of the screen. As an alternative, the digital broadcast receiver can be constructed in such a way as to display the implementation status of the acquisition of the program information from each broadcast station in a right end portion of the screen. The digital broadcast receiver can be alternatively constructed in such a way as to display the implementation status of the acquisition of the program information from each broadcast station in a horizontal direction in an upper or lower end portion of the screen.

Furthermore, the digital broadcast receiver in accordance with Embodiment 1 is constructed in such a way as not to display the logo of each broadcast station from which the program information has not been acquired yet (display the logo at 100% of transmittance). As an alternative, the digital broadcast receiver can be constructed in such a way as to display a rectangle having the same size as the broadcast station logo, and also display the name of the broadcast station in the rectangle. The digital broadcast receiver having this structure enables the user to easily grasp how many broadcast stations from each of which the program information has not been acquired yet remain to be processed.

Instead of not displaying the logo of each broadcast station from which the program information has not been acquired yet (display the logo at 100% of transmittance), the digital broadcast receiver in accordance with Embodiment 1 can be constructed in such a way as to limit the transmittance of the logo of each broadcast station from which the program information has not been acquired yet to such an extent that the broadcast station logo is thinly transparent and is slightly visible (e.g., 80% of transmittance). The digital broadcast receiver having this structure enables the user to easily grasp how many broadcast stations from each of which any program information has not been acquired yet remain to be processed.

Furthermore, the digital broadcast receiver in accordance with Embodiment 1 is constructed in such a way as to display the logo of each broadcast station from which the digital broadcast receiver is acquiring the program information in a semi-transparent form. As an alternative, the digital broadcast receiver can be constructed in such a way as to add a prominent decoration to the logo of each broadcast station from which the digital broadcast receiver is acquiring the program information by drawing the outer frame of the broadcast station logo with a heavy line, blinking the outer frame line, or changing the color of the outer frame line periodically.

In addition, the digital broadcast receiver in accordance with Embodiment 1 is constructed in such a way as to display the status of the acquisition of the program information from each broadcast station with the transmittance of the logo of each broadcast station. As an alternative, the digital broadcast receiver can be constructed in such a way as to draw all the broadcast station logos in an untransparent form, and show the status of the acquisition of the program information from each broadcast station by using the color of the outer frame line of the logo of each broadcast station. For example, the digital broadcast receiver can be constructed in such a way as to show that the digital broadcast receiver has acquired the program information from a broadcast station by displaying the outer frame line of the corresponding broadcast station logo in blue, show that the digital broadcast receiver is acquiring the program information from a broadcast station by displaying the outer frame line of the corresponding broadcast station logo in yellow, and show that the digital broadcast receiver has not acquired the program information yet from a broadcast station by displaying the outer frame line of the corresponding broadcast station logo in red, for example. Similarly, the digital broadcast receiver can show the status of the acquisition of the program information from each broadcast station by changing either the thickness (thick, medium, or thin) or the pattern (a solid line, a broken line, or a dotted line) of the outer frame line of the logo of each broadcast station.

In addition, the digital broadcast receiver in accordance with Embodiment 1 is constructed in such a way as to display only the logo of each broadcast station. As an alternative, the digital broadcast receiver can be constructed in such a way as to display a pair of the logo and name of each broadcast station.

### Embodiment 2

A digital broadcast receiver in accordance with Embodiment 2 of the present invention has the same functional structure as the digital broadcast receiver in accordance with Embodiment 1 shown in FIG. 1.

The digital broadcast receiver in accordance with this Embodiment 2 includes, as broadcast information which the digital broadcast receiver collects in parallel with reproduction of a program currently being watched, a frequency list, the reception status of relay stations, the reception status of affiliated stations, and so on, in addition to program information explained in Embodiment 1, and switches among the program information, the frequency list, the reception status of relay stations and the reception status of an affiliated station, and so on as needed. Accordingly, a time period during which a broadcast information collection unit 14 is at rest can be eliminated, and an effective use of the broadcast information collection unit 14 is achieved.

The frequency list is information about an addition of a broadcast station or a relay station, or a change of frequency assignment, and is sent out via broadcast. Even a digital television receiver for home use needs to download, update and store a frequency list.

Each of the reception status of a relay station (another station which broadcasts the same broadcast content as that provided by the station which is being watched), and the reception status of an affiliated station (another station which broadcasts partially the same broadcast content as that provided by the station which is being watched) is information required in order to switch to a relay station or affiliated station having a good reception status promptly when the reception status of the station from which the program being watched is being received gets worse when the digital broadcast receiver is a digital television receiver used for a vehicle and moves from a region to another region. The monitoring of relay stations and affiliated stations is carried out by repeatedly carrying out a selection of one of all the broadcast stations registered for about several seconds to check the reception status of the broadcast station selected, and a selection of the next broadcast station.

Criteria by which to judge whether to switch among the pieces of broadcast information to be collected can be determined as follows. More specifically, priorities are assigned to the pieces of broadcast information respectively. Then, when a necessity to collect broadcast information having a higher priority occurs, the digital television receiver interrupts the collection of broadcast information having a lower priority and switches to collection of the broadcast information having a higher priority, and, when the collection of the broadcast information having a higher priority is completed, restarts the collection of the broadcast information having a lower priority. For example, priorities are assigned to the pieces of broadcast information respectively in such a way that the download of the frequency list has a high priority, the acquisition of the program information has a medium priority, and the monitoring of relay stations and affiliated stations has a low priority.

The switching among the pieces of broadcast information to be collected can be implemented by, in a multitask processing system, allocating the download of the frequency list, the acquisition of program information, and the monitoring of relay stations and affiliated stations to three tasks having different priorities, and by mounting a mechanism of enabling a suspension or restart of each process via message communications among the tasks. This method is typically used in software for various types of embedded equipment.

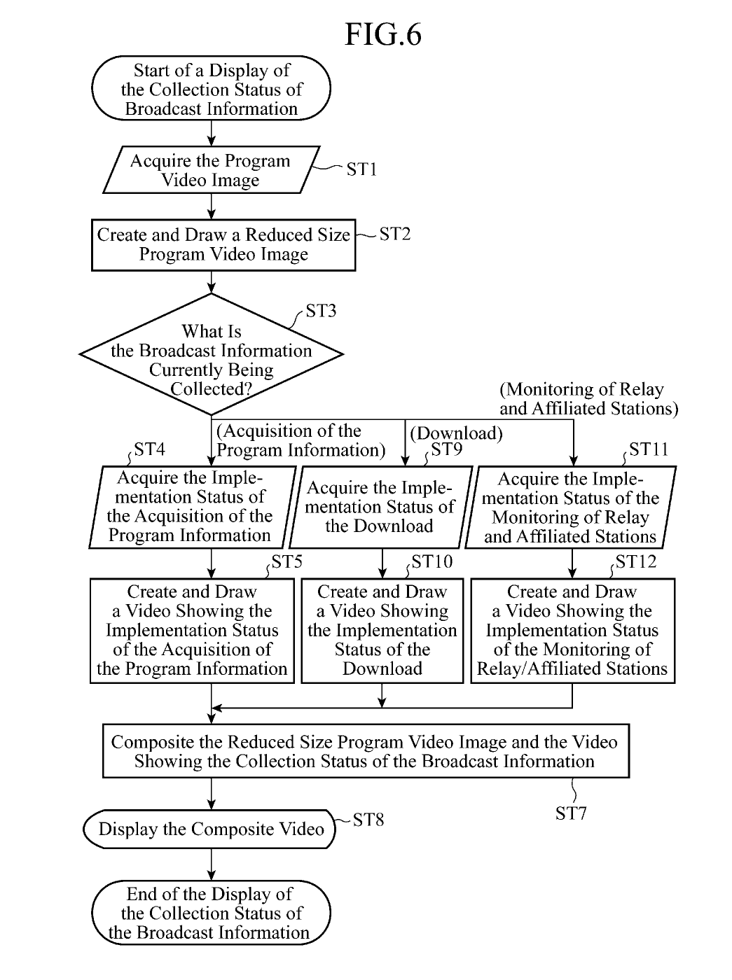

Next, the operation of the digital broadcast receiver in accordance with Embodiment 2 of the present invention will be explained with reference to a flow chart shown in FIG. 6, focusing on a process of displaying the collection status of the broadcast information. In the flow chart shown in FIG. 6, steps which are the same as those in the broadcast information collection status display process carried out by the digital broadcast receiver in accordance with Embodiment 1 shown in the flow chart of FIG. 2 or like steps are designated by the same reference characters as those used in FIG. 2, and the explanation of the steps will be simplified hereafter.

In the process of displaying the collection status of broadcast information, a program video image is acquired first (step ST1). Then, creation of a reduced size image from the program video image and drawing of the reduced size image are carried out (step ST2). The broadcast information currently being collected is then checked to see (step ST3). More specifically, a display control unit 11 acquires the broadcast information currently being collected from a collection status generation unit 19, and, when the program information is being acquired, advances to step ST4, when the frequency list is being downloaded, advances to step ST9, or, when relay and affiliated stations are being monitored, advances to step ST11.

The implementation status of the acquisition of the program information is acquired in step ST4. Creation and drawing of an image showing the implementation status of the acquisition of the program information are then carried out (step ST5). After that, the digital broadcast receiver advances the sequence to step ST7.

The implementation status of the download is acquired in step ST9. More specifically, the display control unit 11 acquires the ratio of the already-acquired part of the frequency list and the remaining part of the frequency list (the already-acquired data volume/the total data volume) from the collection status generation unit 19. The display control unit 11 can know the total data volume of the frequency list by extracting a DII (Download Information Indication message) about the frequency list from information repeatedly transmitted thereto in a DSM-CC (Digital Storage Media-Command and Control) section form and then analyzing the DII. This analyzing method is the same as that for use in a case in which a digital television receiver for home use downloads a frequency list.

Creation and drawing of an image showing the implementation status of the download are then carried out (step ST10). More specifically, the display control unit 11 creates a graphic (e.g., a progress bar for use in a personal computer and so on) showing the ratio of the already-acquired part of the frequency list and the remaining part of the frequency list, and adjusts the length of the progress bar according to the ratio to draw the bar. After that, the digital broadcast receiver advances the sequence to step ST7.

In step ST11, the implementation status of the monitoring of relay and affiliated stations is acquired. More specifically, the display control unit 11 acquires a list of relay stations and affiliated stations, and the reception status of each relay station and the reception status of each affiliated station (including information showing whether or not the reception status is good, and information showing that the reception status information is being received or has not been received) from the collection status generation unit 19. As an index showing whether or not the reception status is good, C/N can be used, for example. The C/N is the ratio of the carrier wave (Carrier) to noise (Noise), and the larger the value of the C/N, the better the reception status. The C/N is calculated according to the following equation (1), and is expressed in decibels [dB].

C/N=10*log(PC/PN) (1)

where PC is the carrier power [W] and PN is the noise power [W]

Creation and drawing of an image showing the implementation status of the monitoring of relay and affiliated stations are then carried out (step ST12). More specifically, when a broadcast station has a C/N value which is equal to or larger than a first threshold, the display control unit 11 determines that the reception status of the broadcast station is good, and draws the logo of the broadcast station at 0% of transmittance (untransparent). When a broadcast station has a C/N value which is equal to or smaller than a second threshold, the display control unit 11 determines that the reception status of the broadcast station is bad, and draws the logo of the broadcast station at 100% of transmittance (transparent). When a broadcast station has a C/N value smaller than the first threshold and larger than the second threshold, the display control unit 11 draws the logo of the broadcast station at a degree of transmittance which the display control unit 11 determines according to the following equation (2). In this case, the second threshold<the first threshold. After that, the digital broadcast receiver advances the sequence to step ST7.

Transmittance=(C/N value−second threshold)/(first threshold−second threshold)×100 (2)

In step ST7, the normal size program video image and an image showing the collection status of the broadcast information are composited into a composite image. The composite image is then displayed (step ST8). After that, the digital broadcast receiver ends the process of displaying the collection status of the broadcast information.

In the above-mentioned broadcast information collection status display process, a conceptual screen display which is produced in a case in which the digital broadcast receiver goes via steps ST4 and ST5 is the same as that in the case of the digital broadcast receiver in accordance with Embodiment 1 shown in FIG. 3.

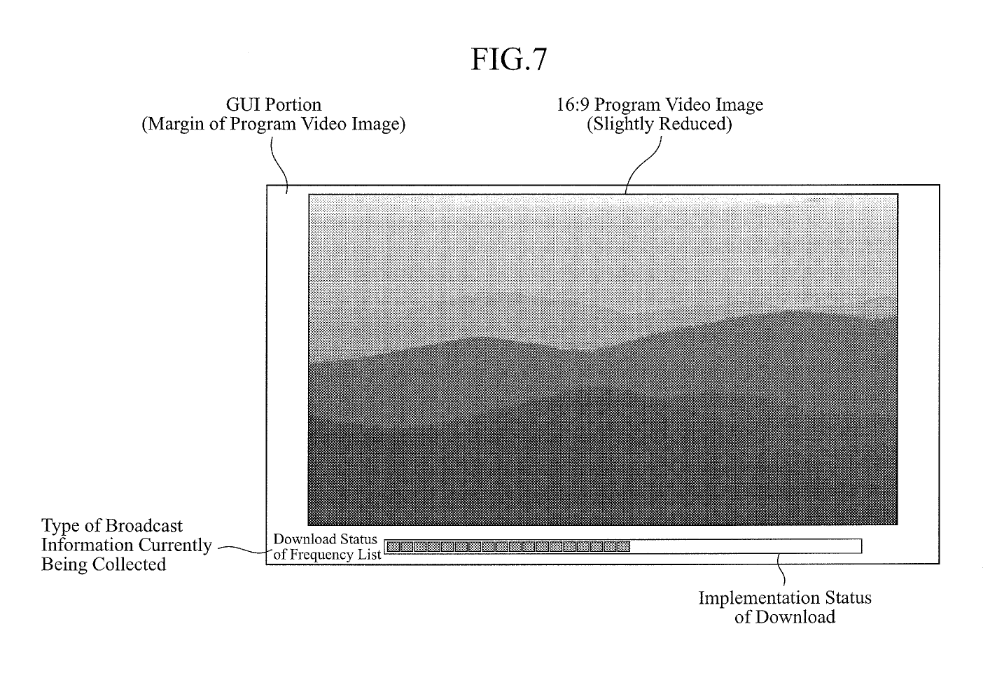

FIG. 7 shows a conceptual screen display which is produced when the frequency list is being downloaded in a case in which the digital broadcast receiver goes via steps ST9 and ST10, and shows an image of mountains which is a slightly-reduced program video image of “16:9”. In the figure, an oblong graphic (a progress bar) arranged in a margin under the program video image shows the implementation status of the download of the frequency list.

FIG. 8 shows a conceptual screen display which is produced when relay stations and affiliated stations are being monitored in a case in which the digital broadcast receiver goes via steps ST11 and ST12, and shows an image of mountains which is a slightly-reduced program video image of “16:9”. In the figure, each of broadcast station logos arranged in a right side margin and running in a vertical direction shows the implementation status of the monitoring of a corresponding one of the relay stations and affiliated stations.

As previously explained, because the digital broadcast receiver in accordance with Embodiment 2 of the present invention is constructed in such a way as to change the screen display to be produced according to the status of the implementation of the collection of broadcast information which is one of “the acquisition of program information”, “the download of a frequency list”, and “the monitoring of relay stations and affiliated stations”, the digital broadcast receiver enables the user to easily grasp which one of the processes is carried out in parallel with the reproduction of the program currently being watched by the user. Therefore, the frequency with which the user feels burdensome to wait for a display of either the broadcast reception status of each station or the program information about each station after commanding the digital broadcast receiver to display either the broadcast reception status of each station or the program information about each station while the digital broadcast receiver makes an update of the frequency list which requires much time can be reduced.

The digital broadcast receiver in accordance with above-mentioned Embodiment 2 is constructed in such a way as to set the display position of the implementation status of the collection of broadcast information in a left end portion of the screen when acquiring the program information, set the display position of the implementation status in a lower end portion of the screen when downloading the frequency list, and set the display position of the implementation status in a right end portion of the screen when monitoring relay stations and affiliated stations. As an alternative, the digital broadcast receiver can be constructed in such a way as to always display the implementation status of the collection of broadcast information at the same position regardless of the collected broadcast information.

Furthermore, in the digital broadcast receiver in accordance with Embodiment 2, the example using the following three types of processes of collecting broadcast information: “the acquisition of program information”, “the download of a frequency list”, and “the monitoring of relay stations and affiliated stations” is shown. This embodiment is not limited to this example. Furthermore, the target for download is not limited to a frequency list, and can be software used for receiver.

In addition, in the digital broadcast receiver in accordance with Embodiment 2, priorities are assigned to the pieces of broadcast information respectively in such a way that the download of a frequency list has a high priority, the acquisition of program information has a medium priority, and the monitoring of relay stations and affiliated stations has a low priority, though the priorities assigned to the pieces of broadcast information respectively are not limited to this example, and can be set up arbitrarily.

Furthermore, the digital broadcast receiver in accordance with Embodiment 2 is constructed in such a way as to use a C/N as an index showing whether or not the reception status of each broadcast station is good. As an alternative, the digital broadcast receiver can use the following parameters as an index: the electric field strength of the received radio wave, a BER (Bit Error Rate) at the time of carrying out digital demodulation, the result of a comparison with an error correcting code at the time of separating various pieces of information from a TS, the frequency of occurrence of errors at the time of decoding the video image or audio, or the like. The digital broadcast receiver can be alternatively constructed in such a way as to use an index which is a combination of some of the comparison result, the frequency of occurrence of errors, and the combination of the above-mentioned parameters can also be used as an index.

Furthermore, in the digital broadcast receiver in accordance with Embodiment 2, a progress bar is used as the graphic showing the implementation status of the download of a frequency list, though another graphic, such as a pie chart, can be alternatively used.

### Embodiment 3

A digital broadcast receiver in accordance with Embodiment 3 of the present invention has the same functional structure as the digital broadcast receiver in accordance with Embodiment 1 shown in FIG. 1.

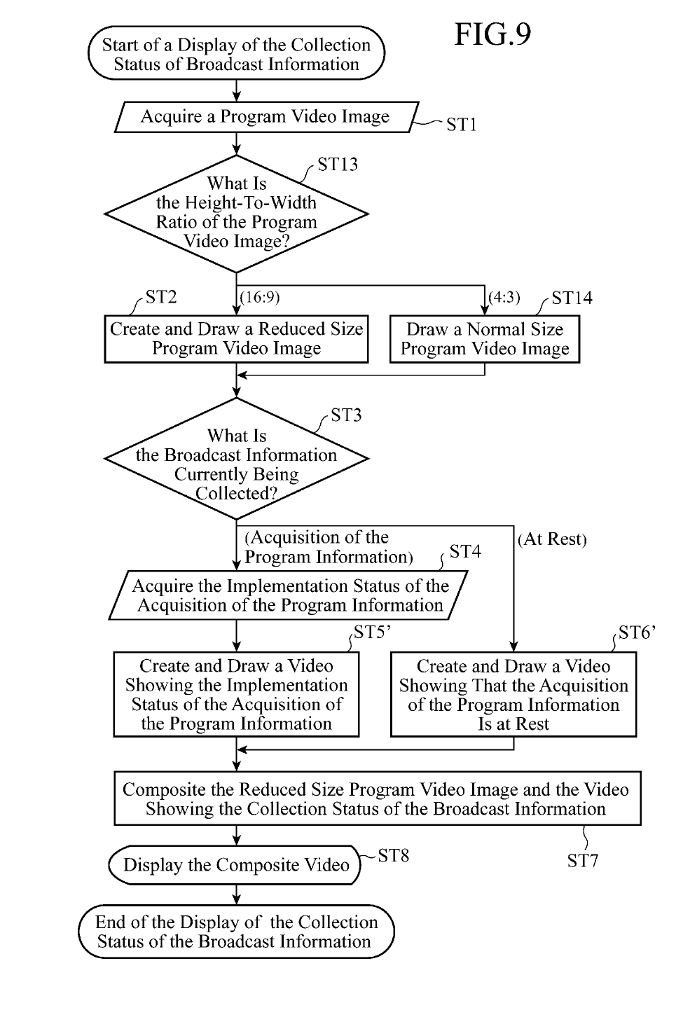

Next, the operation of the digital broadcast receiver in accordance with Embodiment 3 of the present invention will be explained with reference to a flow chart shown in FIG. 9, focusing on a process of displaying the collection status of broadcast information. In the flow chart shown in FIG. 9, steps which are the same as those in the broadcast information collection status display process carried out by the digital broadcast receiver in accordance with Embodiment 1 shown in the flow chart of FIG. 2 or like steps are designated by the same reference characters as those used in FIG. 2, and the explanation of the steps will be simplified hereafter.

In the process of displaying the collection status of broadcast information, a program video image is acquired first (step ST1). The height-to-width ratio of the program video image is then checked to see (step ST13). More specifically, a display control unit 11 checks to see the height-to-width ratio of the program video image acquired in step ST1. When the height-to-width ratio is “16:9”, the display control unit 11 advances to step ST2, whereas when the height-to-width ratio is “4:3”, the display control unit 11 advances to step ST14. The display control unit 11 can know the height-to-width ratio of the program video image by analyzing the sequence header information added to the program video image. The display control unit 11 can analyze the sequence header information by using the same method as that used by a digital television receiver for home use.

In step ST2, creation of a reduced size image from the program video image and drawing of the reduced size image are carried out. After that, the digital broadcast receiver advances the sequence to step ST3. In step ST14, drawing of a normal size program video image is carried out. More specifically, the display control unit 11 draws the program video image in a moving image plane in such a way that the program video image has a size which falls within the display screen height (a reduced size image which is not reduced in size). Because a display for use with a digital television receiver or a vehicle-mounted car navigation device has a display screen size of “16:9” substantially, a blank part (a black belt) appears at each of right and left ends of the screen when a program video image of “4:3” is displayed. After that, the digital broadcast receiver advances the sequence to step ST3.

The broadcast information currently being collected is checked to see in step ST3. More specifically, the display control unit 11 acquires the broadcast information currently being collected from a collection status generation unit 19, and, when the digital broadcast receiver is acquiring the program information, advances to step ST4, whereas when the digital broadcast receiver has completed the acquisition of the program information and is at rest, the display control unit 11 advances to step ST6′.

The implementation status of the acquisition of the program information is acquired in step ST4. Creation and drawing of an image showing the implementation status of the acquisition of the program information are then carried out (step ST5′). More specifically, the display control unit 11 creates an image showing the status of the acquisition of the program information, like in the case of step ST5 in the broadcast information collection status display process carried out by the digital broadcast receiver in accordance with Embodiment 1 shown in the flow chart of FIG. 2. The position at which the image is drawn in an OSD plane varies according to the height-to-width ratio of the program video image. More specifically, when the height-to-width of the program video image is “16:9”, the display control unit 11 draws the image showing the status of the acquisition of the program information in a margin on a left side of the reduced size image, like that of Embodiment 1. In contrast, when the height-to-width of the program video image is “4:3”, the display control unit 11 draws the image showing the status of the acquisition of the program information in a black belt portion on a left side of the normal size image. After that, the digital broadcast receiver advances the sequence to step ST7.

In step ST6′, the display control unit 11 carries out creation of an image showing that the acquisition of the program information is at rest, like in the case of step ST6 in the broadcast information collection status display process carried out by the digital broadcast receiver in accordance with Embodiment 1 shown in the flow chart of FIG. 2. The position at which the image is drawn in the OSD plane is changed according to the height-to-width ratio of the program video image, like in step ST5′. After that, the digital broadcast receiver advances the sequence to step ST7.

In step ST7, either the normal size program video image or the normal size program video image and an image showing the collection status of the broadcast information are composited into a composite image. The composite image is then displayed (step ST8). After that, the digital broadcast receiver ends the process of displaying the collection status of the broadcast information.

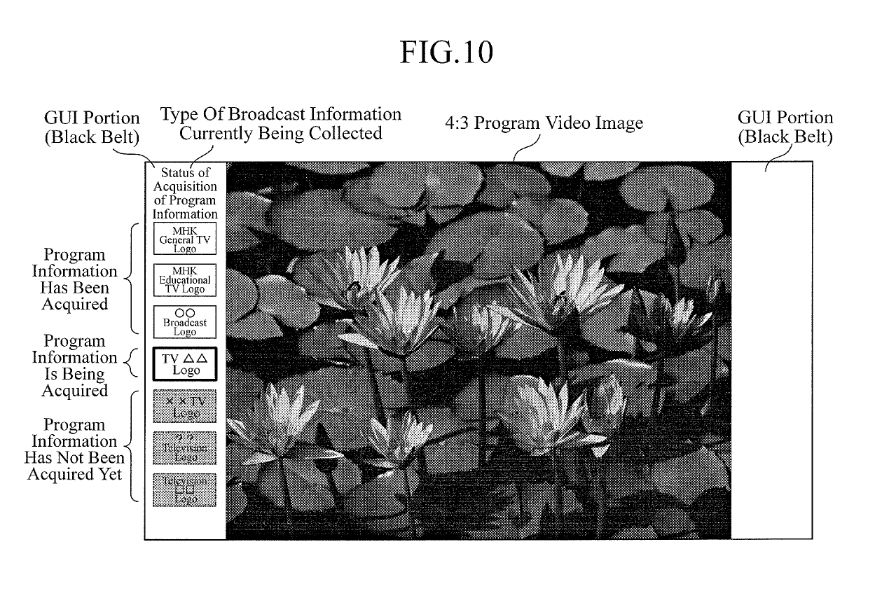

In the above-mentioned broadcast information collection status display process, a conceptual screen display which is produced in a case in which the digital broadcast receiver goes via step ST2 is the same as that in the case of the digital broadcast receiver in accordance with Embodiment 1 shown in FIG. 3. FIG. 10 shows a conceptual screen display for displaying the status of the acquisition of the program information together with the program video image of “4:3” in the case in which the digital broadcast receiver goes via step ST14. In FIG. 10, an image of flowers in the central portion of the screen shows the program video image of “4:3”. In the figure, the right and left side portions are typically called black belts, and each of broadcast station logos arranged in the left side black belt and running in a vertical direction shows the status of the acquisition of the corresponding program information.

As previously explained, because when the user is watching a program video image of “4:3”, the digital broadcast receiver in accordance with Embodiment 3 of the present invention does not reduce the video image, the digital broadcast receiver can display the collection status of the broadcast information without impairing the visibility of the program video image. Furthermore, even when the user is watching a program video image of “16:9”, the digital broadcast receiver can display the collection status of the broadcast information with almost no impairment of the visibility of the program video image.

The digital broadcast receiver in accordance with above-mentioned Embodiment 3 is constructed in such a way as to change the drawing position according to the height-to-width ratio of the program video image when the digital broadcast receiver is acquiring the program information or is in a resting state in which it is not acquiring the program information. Furthermore, the digital broadcast receiver in accordance with Embodiment 3 can be constructed in such a way as to change the drawing position according to the height-to-width ratio of the program video image also when downloading a frequency list or monitoring relay stations and affiliated stations.

### Embodiment 4

A digital broadcast receiver in accordance with Embodiment 4 of the present invention has the same functional structure as the digital broadcast receiver in accordance with Embodiment 1 shown in FIG. 1.

A subtitle is a service for superimposing information associated with the program video image onto the program video image to display the information, and character superimposing is a service for superimposing information not associated with the program video image onto the program video image to display the information. Their display positions are determined in such a way that a subtitle is displayed in a lower portion of the screen, and superimposed characters are displayed in an upper portion of the screen. Their display timings are determined in such a way that a subtitle is synchronized with the program video image, and superimposed characters are not synchronized with the program video image.

A subtitle or superimposed characters are transmitted in an independent PES (Packetized Elementary Stream) form. A first information demultiplex unit 4 separates an independent PES from a TS inputted thereto to extract and analyze the information about a subtitle or superimposed characters, and stores this information in an information storage unit 18. When a subtitle or superimposed characters are included in the broadcast information stored in the information storage unit 18, a display control unit 11 creates an image of the subtitle or superimposed characters, draws this image in a subtitle or character superimposing plane at a correct portion and with a correct timing, and superimposes the image onto the program video image to display the image. This process is the same as that carried out by a digital television receiver for home use.

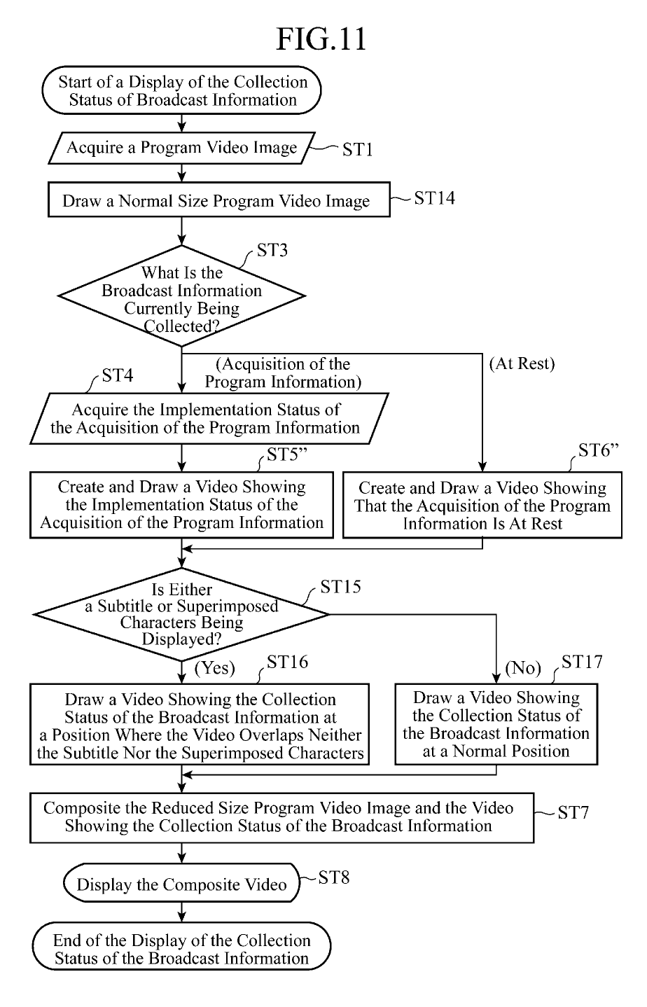

Next, the operation of the digital broadcast receiver in accordance with Embodiment 4 of the present invention will be explained with reference to a flow chart shown in FIG. 11, focusing on a process of displaying the collection status of broadcast information. In the flow chart shown in FIG. 11, steps which are the same as those in the broadcast information collection status display process carried out by the digital broadcast receiver in accordance with Embodiment 1 shown in the flow chart of FIG. 2, those in the broadcast information collection status display process carried out by the digital broadcast receiver in accordance with Embodiment 3 shown in the flow chart of FIG. 9, or like steps are designated by the same reference characters as those used in FIG. 2 or 9, and the explanation of the steps will be simplified hereafter.

In the process of displaying the collection status of broadcast information, a program video image is acquired first (step ST1). Drawing of a normal size program video image is then carried out (step ST14). The broadcast information currently being collected is then checked to see (step ST3). More specifically, the display control unit 11 acquires the broadcast information currently being collected from a collection status generation unit 19, and, when the digital broadcast receiver is acquiring the program information, advances to step ST4, whereas when the digital broadcast receiver has completed the acquisition of the program information and is in a resting state, the digital broadcast receiver advances to step ST6″.

The implementation status of the acquisition of the program information is acquired in step ST4. Creation of an image showing the implementation status of the acquisition of the program information is then carried out (step ST5″). Although the process in this step ST5″ is the same as that in step ST5 of the flow chart shown in FIG. 2 in that the process in step ST5″ includes up to the process of creating the image showing the implementation status of the acquisition of the program information using broadcast station logos, but differs from the process in step ST5 of the flow chart shown in FIG. 2 in that the created image is not drawn in an OSD plane in this stage. After that, the digital broadcast receiver advances the sequence to step ST15.

In step ST6″, creation of an image showing that the digital broadcast receiver is in the resting state in which it is not acquiring the program information is carried out. Although the process in this step ST6″ is the same as that in step ST6 of the flowchart shown in FIG. 2 in that the process in step ST6″ includes up to the process of creating the image showing that the digital broadcast receiver is in the resting state in which it is not acquiring the program information, but differs from the process in step ST6 of the flow chart shown in FIG. 2 in that the created image is not drawn in an OSD plane in this stage. After that, the digital broadcast receiver advances the sequence to step ST15.

In step ST15, it is checked to see whether either a subtitle or superimposed characters are being displayed. More specifically, the display control unit 11 checks to see whether either a subtitle or superimposed characters are being displayed and, when either a subtitle or superimposed characters are being displayed, advances to step ST16, whereas when neither a subtitle nor superimposed characters are being displayed, the display control unit 11 advances to step ST17. Because the display control unit 11 carries out the control of a display of a subtitle or superimposed characters, the display control unit 11 can carry out the checking of whether either a subtitle or superimposed characters are being displayed by checking to see data held thereby.

In step ST16, an image showing the collection status of the broadcast information is drawn at a position where the image overlaps neither the subtitle nor superimposed characters. More specifically, the display control unit 11 computes a position in an OSD plane where the image does not overlap the subtitle or superimposed characters, and draws the image showing the collection status of the broadcast information (the status of the acquisition of the program information or the resting state in which the digital broadcast receiver is not acquiring the program information) at the computed position. The determination of whether the two images overlap each other can use a method generally used for image processing software and so on. After that, the digital broadcast receiver advances the sequence to step ST7.

In step ST17, the image showing the collection status of the broadcast information is drawn at a normal position. More specifically, the display control unit 11 draws the image showing the collection status of the broadcast information (the status of the acquisition of the program information or the resting state in which the digital broadcast receiver is not acquiring the program information) at the determined position in the OSD plane (e.g., in a lower portion of the screen). After that, the digital broadcast receiver advances the sequence to step ST7.

In step ST7, the normal size program video image and the image showing the collection status of the broadcast information are composited into a composite image. The composite image is then displayed (step ST8). After that, the digital broadcast receiver ends the process of displaying the collection status of the broadcast information.

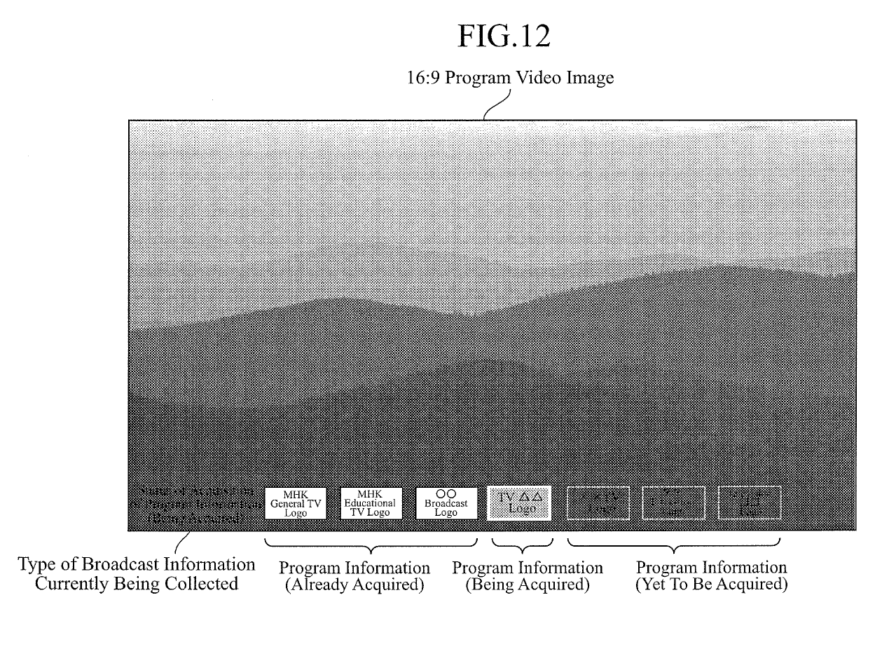

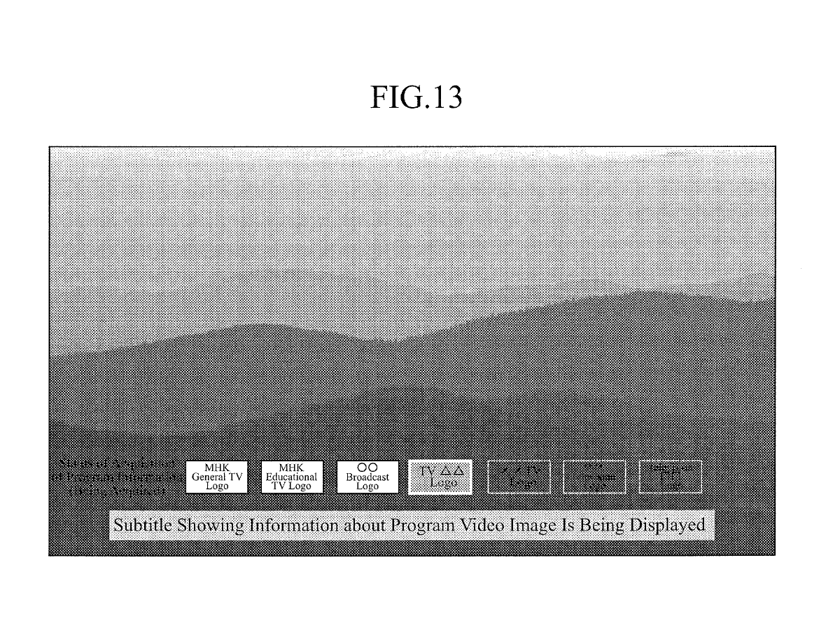

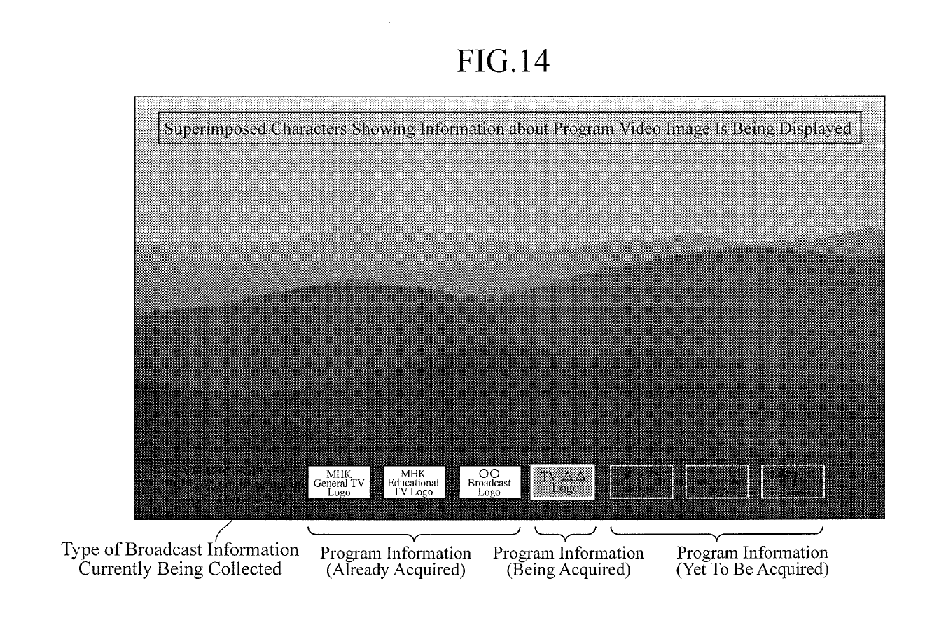

Conceptual screen displays each of which is produced in a case in which the digital broadcast receiver goes via step ST16 in the above-mentioned broadcast information collection status display process are shown in FIG. 13 (with a subtitle) and FIG. 14 (with superimposed characters), and a conceptual screen display which is produced in a case in which the digital broadcast receiver goes via step ST17 is shown in FIG. 12.

FIG. 12 shows a conceptual screen display which is produced in the case of superimposing the status of the acquisition of the program information onto the program video image of “16:9” to display the acquisition status. An image of mountains which occupies the entire screen shows the program video image, and each of broadcast station logos arranged in a lower portion of the screen and running in a horizontal direction shows the status of the acquisition of the corresponding program information.

FIG. 13 shows a conceptual screen display which is produced in the case of superimposing the status of the acquisition of the program information onto the program video image with a subtitle to display the acquisition status. A rectangle in a lower portion of the screen and a character string in the rectangle show the subtitle. In this example of FIG. 13, the image showing the status of the acquisition of the program information is drawn slightly above the position of the image shown in FIG. 12 in such a way that the image does not overlap the subtitle.

FIG. 14 shows a conceptual screen display which is produced in the case of superimposing the status of the acquisition of the program information onto the program video image with superimposed characters to display the acquisition status. In FIG. 14, a rectangle in an upper portion of the screen and a character string in the rectangle show the superimposed characters. In this example of FIG. 14, because the image showing the status of the acquisition of the program information does not overlap the superimposed characters from the first, the image showing the status of the acquisition of the program information is drawn at the same position as that shown in FIG. 12.

As previously explained, because the digital broadcast receiver in accordance with Embodiment 4 of the present invention does not to reduce the video image, the digital broadcast receiver can display the collection status of broadcast information without impairing the visibility of the video image itself. Furthermore, even when the program video image has a subtitle or superimposed characters, the digital broadcast receiver can display the collection status of broadcast information without impairing the visibility of the subtitle or superimposed characters.

Although the case in which the digital broadcast receiver in accordance with above-mentioned Embodiment 4 produces a conceptual screen display including only a subtitle or superimposed characters, the digital broadcast receiver in accordance with above-mentioned Embodiment 4 can alternatively produce a screen display simultaneously including both a subtitle and superimposed characters.

Furthermore, the digital broadcast receiver in accordance with Embodiment 4 is constructed in such a way as to change the drawing position at which the digital broadcast receiver draws the collection status of broadcast information according to the presence or absence of a subtitle. However, because the drawing position of a subtitle and that of superimposed characters are fixed, the digital broadcast receiver can be alternatively constructed in such a way as to preset, as the drawing position at which the digital broadcast receiver draws the collection status of broadcast information, a fixed position at which the on-screen collection status overlaps neither a subtitle nor superimposed characters.

### Embodiment 5

A digital broadcast receiver in accordance with Embodiment 5 of the present invention has the same functional structure as the digital broadcast receiver in accordance with Embodiment 1 shown in FIG. 1.

The digital broadcast receiver in accordance with this Embodiment 5 operates in the same way that the digital broadcast receiver in accordance with Embodiment 2 operates (refer to FIG. 6), except for the following point. That is, the digital broadcast receiver in accordance with Embodiment 5 shows the status of the acquisition of program information (refer to FIG. 3), the progress of the download of a frequency list (refer to FIG. 7), and the status of the monitoring of relay stations and affiliated stations (refer to FIG. 8), which are provided by the digital broadcast receiver in accordance with Embodiment 2, by using characters instead of broadcast station logos and graphics.

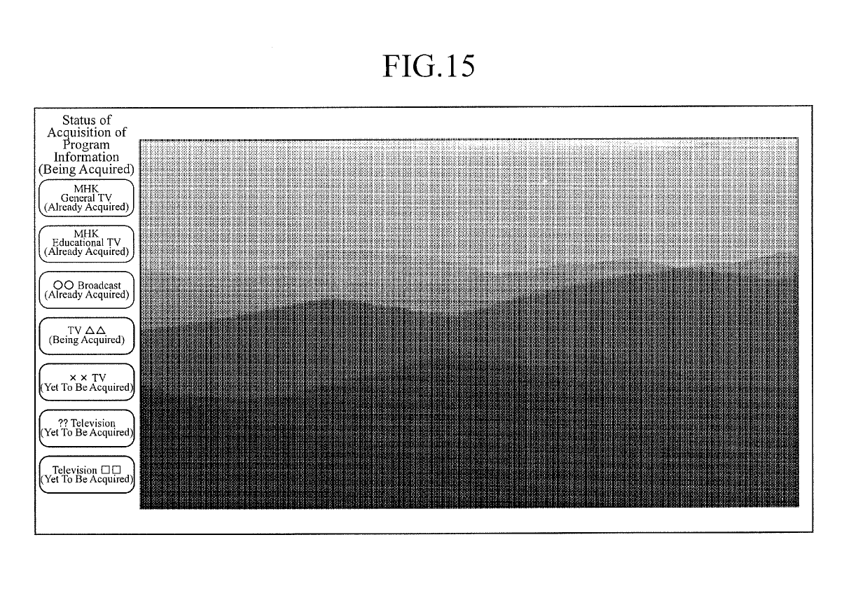

FIG. 15 shows a conceptual screen display which is produced by the digital broadcast receiver in accordance with Embodiment 5 when the digital broadcast receiver is acquiring the program information, and shows an image of mountains which is a slightly-reduced program video image of “16:9”. A character string enclosed by each of rounded rectangles arranged on a left side of the image and running in a vertical direction shows the status of the acquisition of the corresponding program information. An upper character string in each of the rounded rectangles shows a broadcast station name, and a lower character string in the parentheses in each of the rounded rectangles shows the acquisition status (already acquired/being acquired/yet to be acquired).

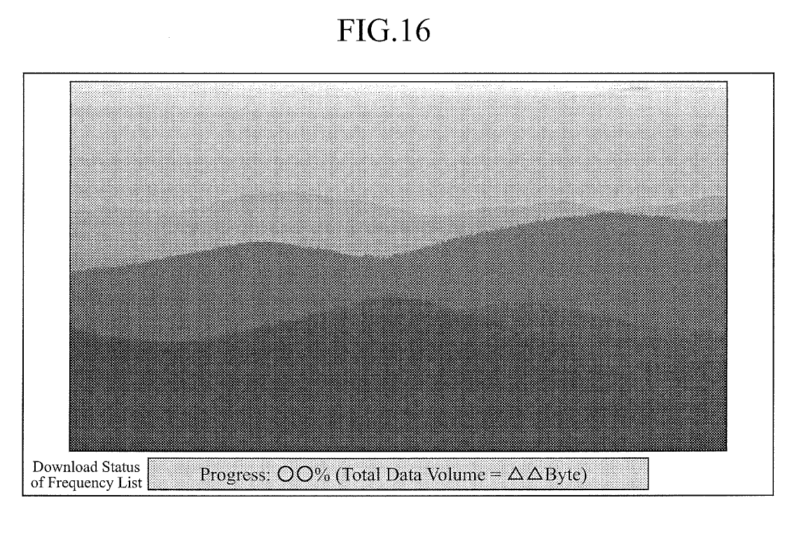

FIG. 16 shows a conceptual screen display which is produced by the digital broadcast receiver in accordance with Embodiment 5 when the digital broadcast receiver is downloading the frequency list, and shows an image of mountains which is a slightly-reduced program video image of “16:9”. A character string in a rectangle arranged in a lower margin under the program video image shows the implementation status of the download. The progress of the download can be calculated by using the same method as that for use in the digital broadcast receiver in accordance with Embodiment 2.

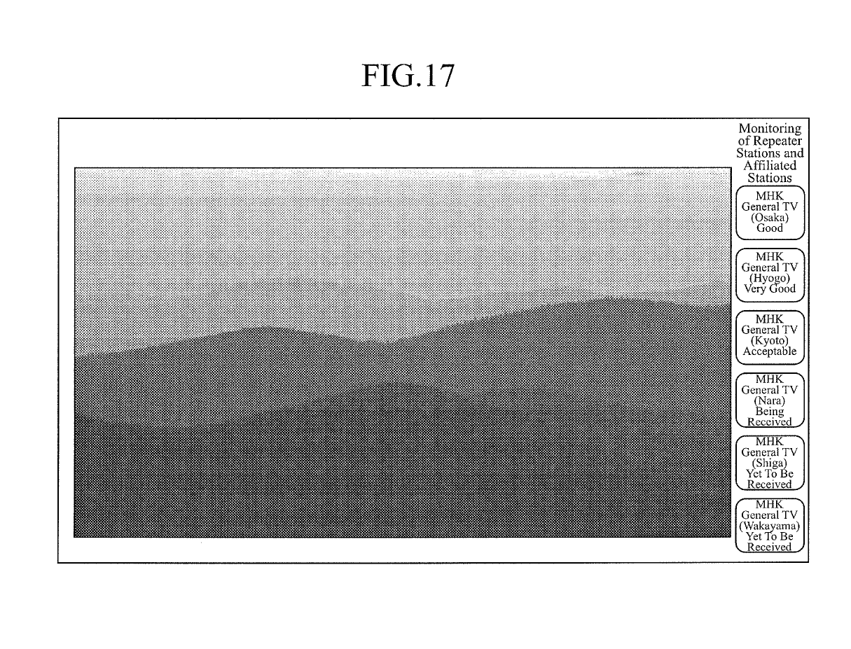

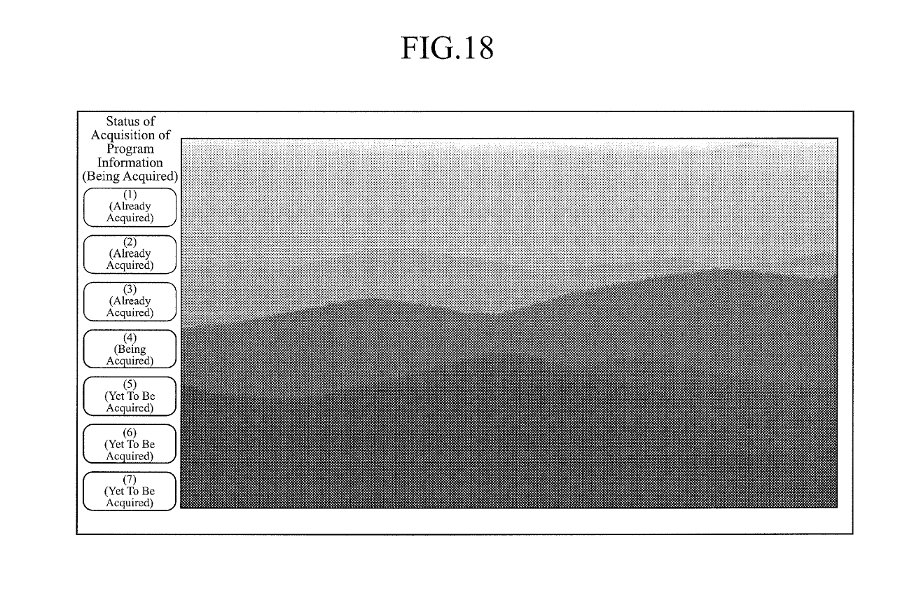

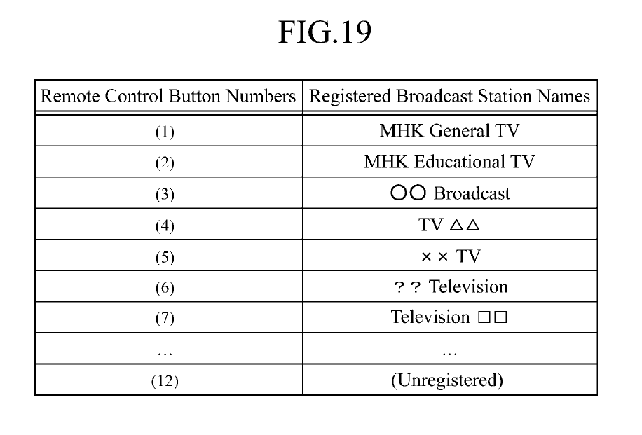

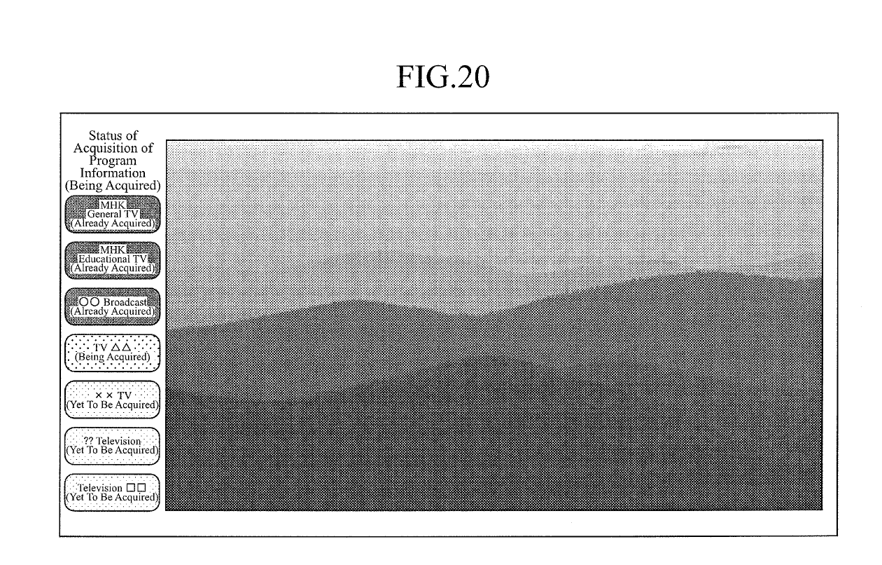

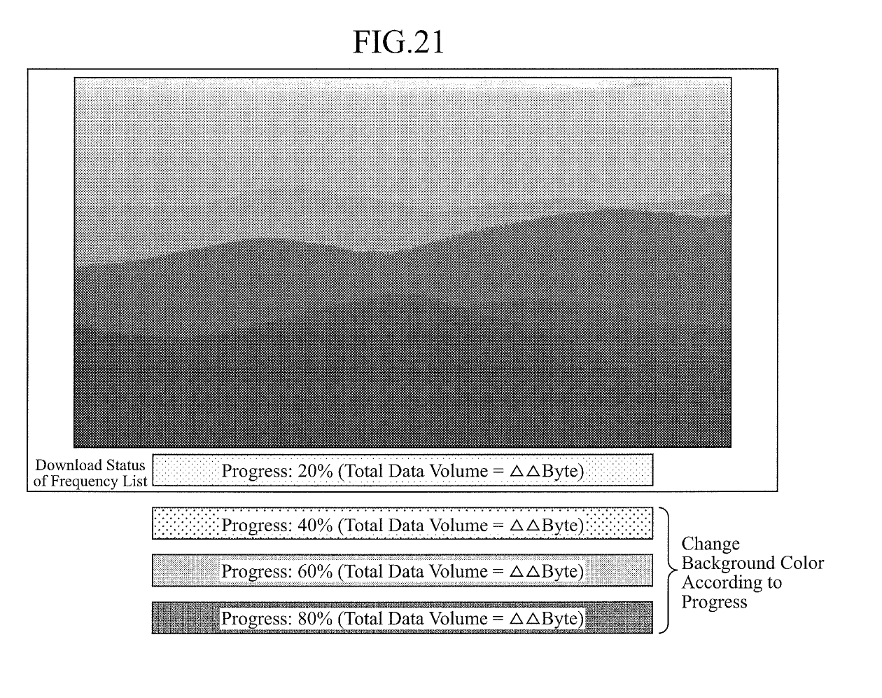

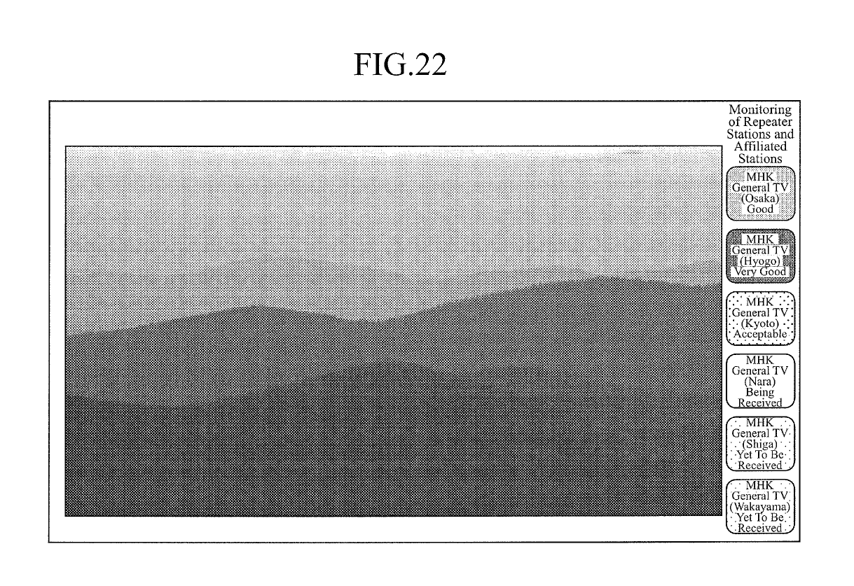

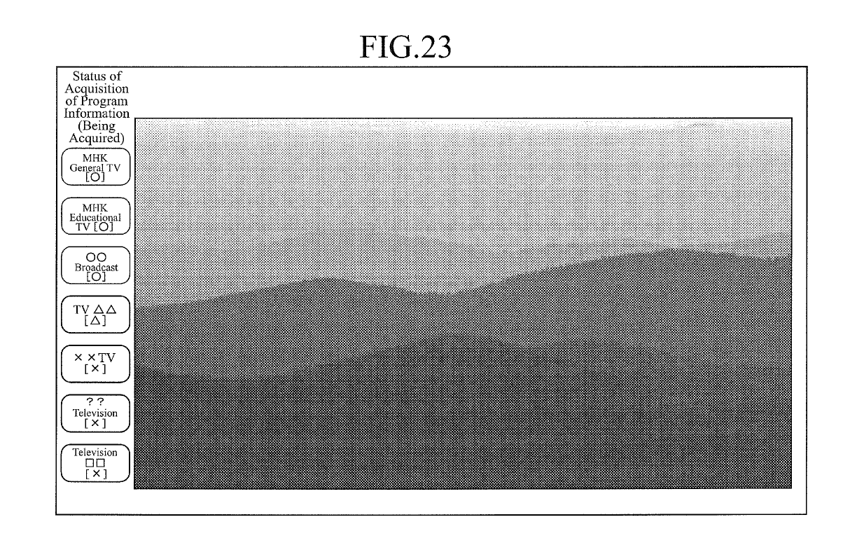

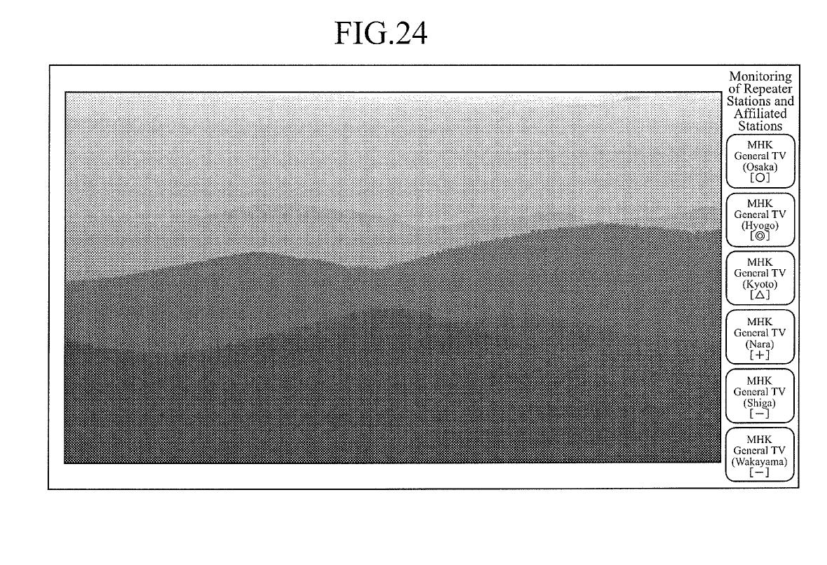

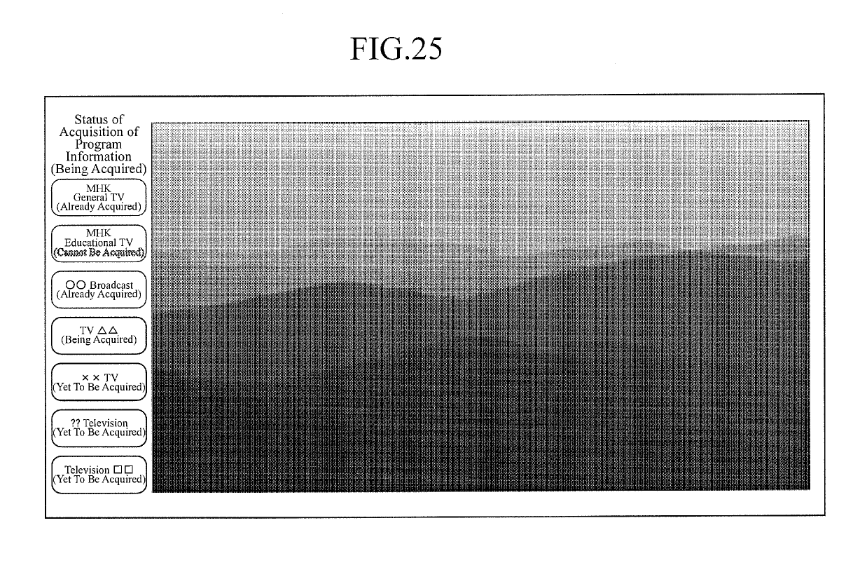

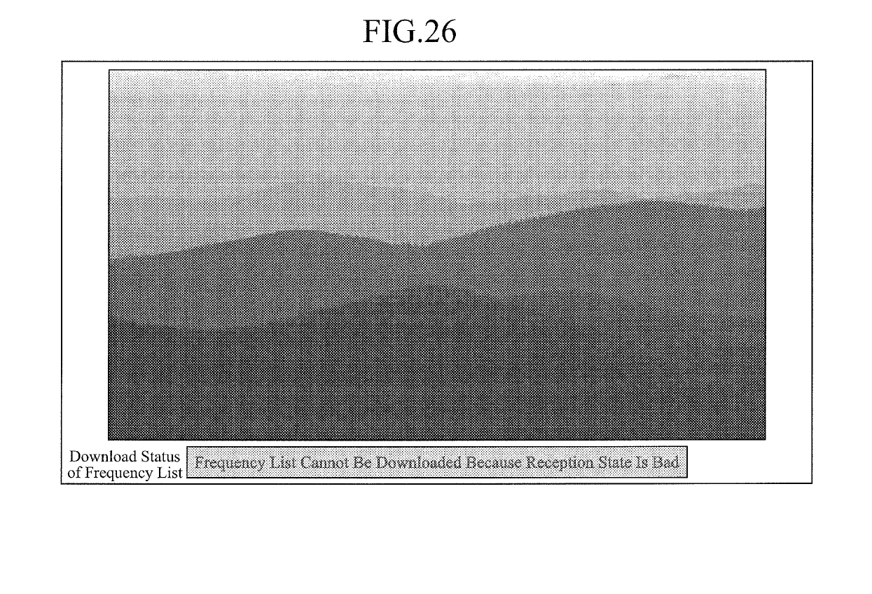

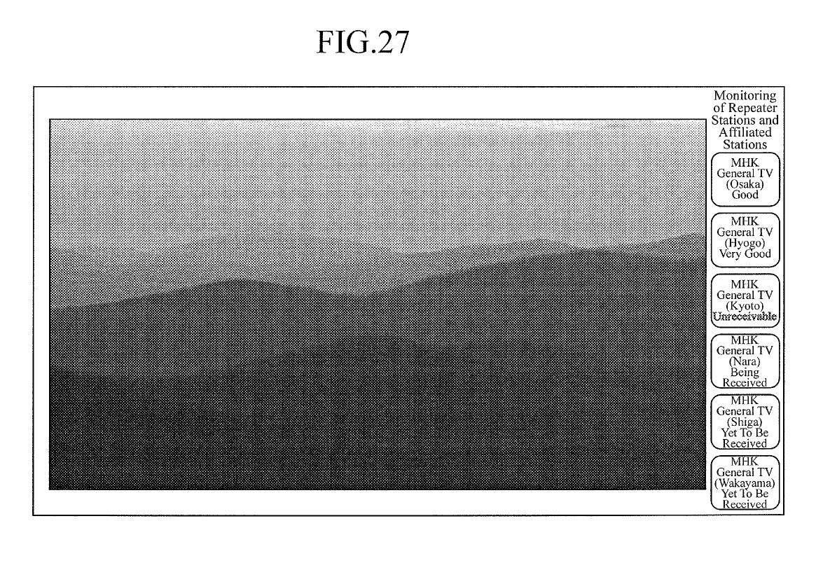

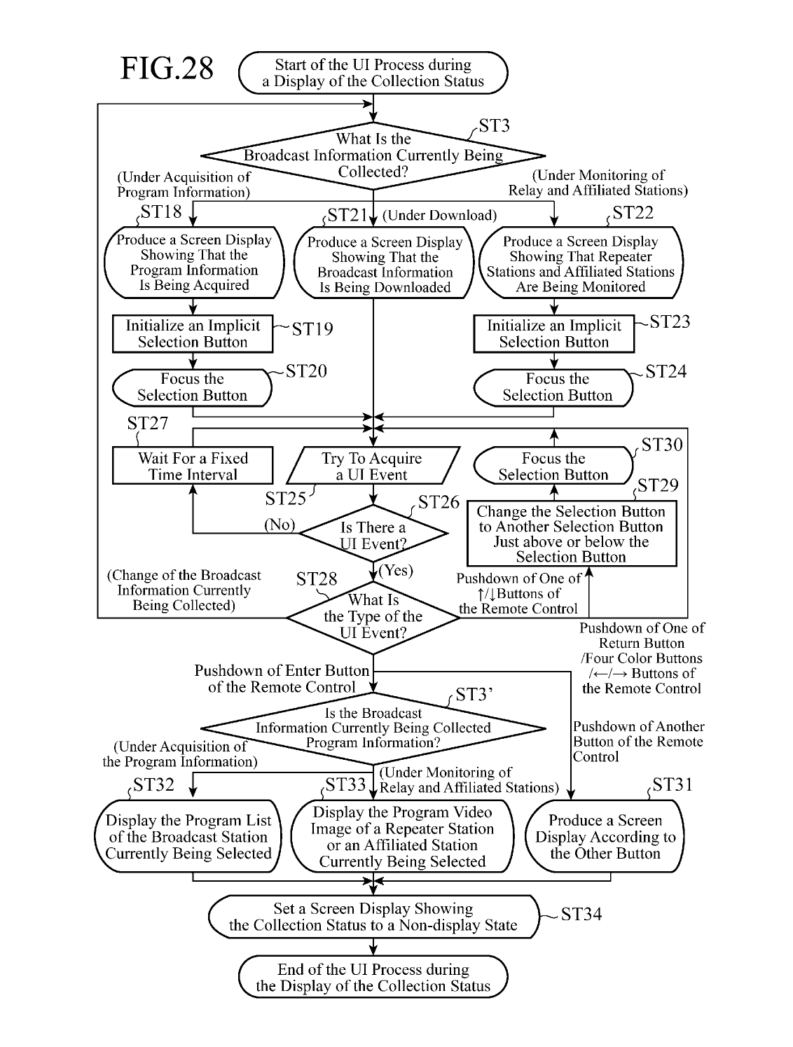

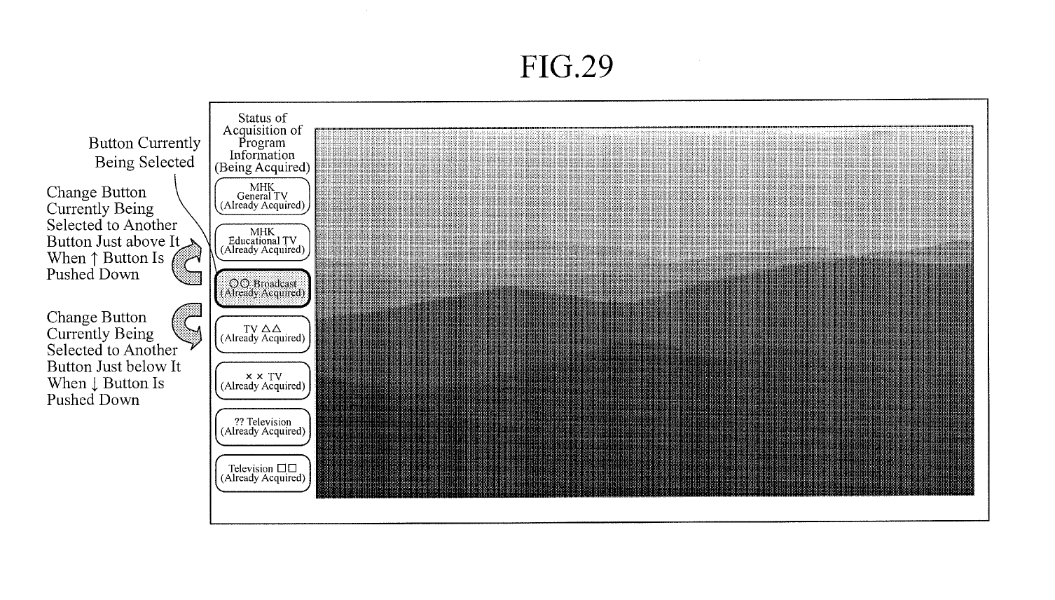

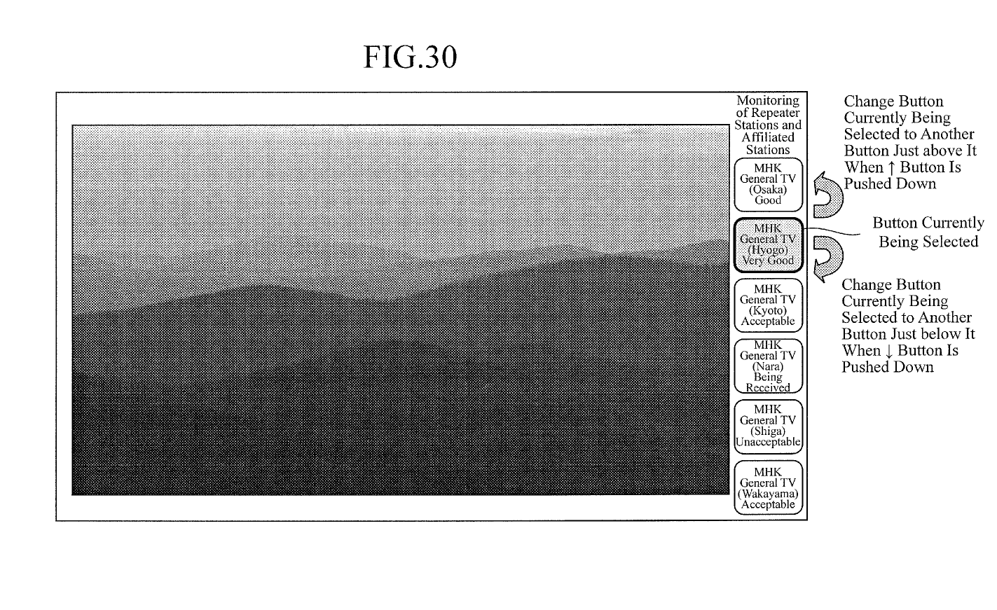

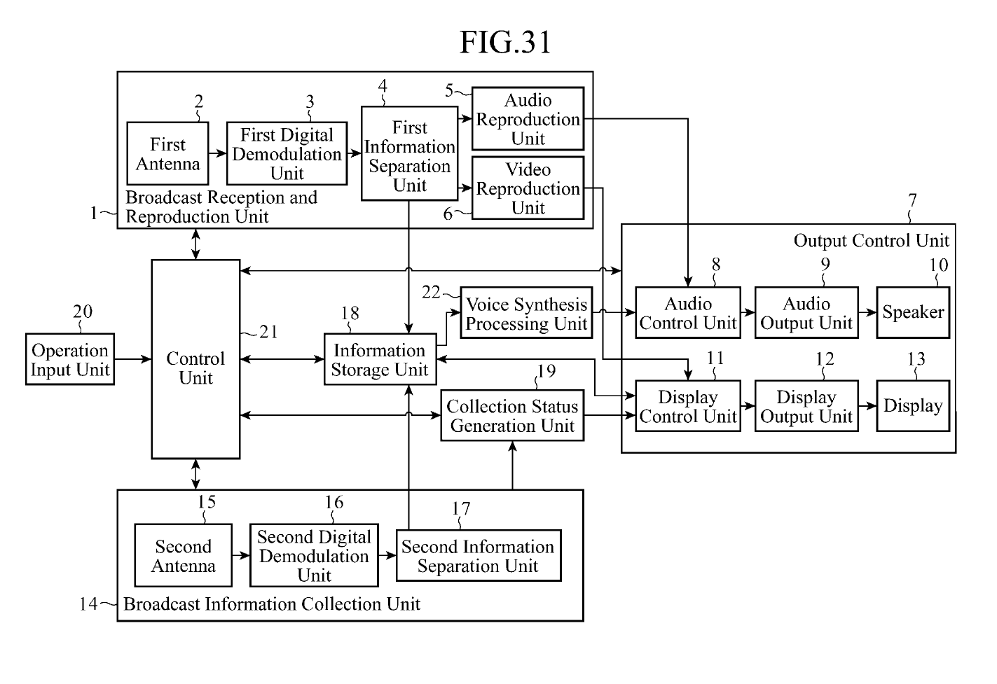

FIG. 17 shows a conceptual screen display which is produced by the digital broadcast receiver in accordance with Embodiment 5 when the digital broadcast receiver is monitoring relay stations and affiliated stations, and shows an image of mountains which is a slightly-reduced program video image of “16:9”. A character string enclosed by each of rounded rectangles arranged in a margin portion on a right side of the image and running in a vertical direction shows the implementation status of a corresponding one of the monitored repeater and affiliated stations. An upper character string and a middle character string in each of the rounded rectangles shows a relay station name and an affiliated station name respectively, and a lower character string in the parentheses in each of the rounded rectangles shows the latest reception status (very good/good/acceptable/not acceptable) or the monitoring status (being received/yet to be received).

The digital broadcast receiver can determine the reception status of each station in such a way that when C/N>=a first threshold, the reception status is very good, when the first threshold>C/N>=a second threshold, the reception status is good, when the second threshold>C/N>=a third threshold, the reception status is acceptable, and, when the third threshold>C/N, the reception status is not acceptable. It is assumed that “the reception status is very good” means a state in which the image has no fluctuations, “the reception status is good” means a state in which the image has partial fluctuations, “the reception status is acceptable” means a state in which the image has large fluctuations, but the broadcast can be received, and “the reception status is not acceptable” means a state in which the broadcast cannot be received and no image cannot be displayed.

As previously explained, because the digital broadcast receiver in accordance with Embodiment 5 of the present invention is constructed in such a way as to display the collection status of broadcast information by using characters, the digital broadcast receiver enables the user to easily grasp the collection status. Furthermore, because the digital broadcast receiver displays the collection status of broadcast information while bringing the collection status of broadcast information into correspondence with the corresponding broadcasting station name, the digital broadcast receiver enables the user to easily grasp the collection status for each broadcast station.

The digital broadcast receiver in accordance with above-mentioned Embodiment 5 uses a broadcast station name as a character string showing either the status of the acquisition of program information or the status of the monitoring of a relay station and an affiliated station. As an alternative, the digital broadcast receiver can use a character string that reminds the user of a broadcast station, such as a service name (there is a case in which one broadcast station provides two or more services, like NHK “registered trademark” Educational TV), or an abbreviation of a broadcast station name (for example, TVO which is the abbreviation of Television Osaka, Inc.).

### Embodiment 6

A digital broadcast receiver in accordance with Embodiment 6 of the present invention has the same functional structure as the digital broadcast receiver in accordance with Embodiment 1 shown in FIG. 1.

The digital broadcast receiver in accordance with this Embodiment 6 operates in the same way that the digital broadcast receiver in accordance with Embodiment 1 operates, except for the following point. That is, the digital broadcast receiver in accordance with Embodiment 6 shows the status of the acquisition of program information (refer to FIG. 3), which is provided by the digital broadcast receiver in accordance with Embodiment 1, by using remote control button numbers (1) to (12) instead of broadcast station logos.

FIG. 18 shows a conceptual screen display which is produced by the digital broadcast receiver in accordance with Embodiment 6 when the digital broadcast receiver is acquiring the program information, and shows an image of mountains which is a slightly-reduced program video image of “16:9”. A character string enclosed by each of rounded rectangles arranged on a left side of the image and running in a vertical direction shows the status of the acquisition of the corresponding program information. The numbers (1) to (7) arranged in the upper rows in the rounded rectangles show the remote control button numbers respectively, and a character string in the parenthesis in each of the rounded rectangles shows the acquisition status of the corresponding program information (already acquired/being acquired/yet to be acquired).

A broadcasting station name registered into each remote control button number can be stored in a table as shown in FIG. 19, for example. As pieces of information stored in this table, information which is prestored in an information storage unit 18 through initial scanning or re-scanning can be used.

As previously explained, because the digital broadcast receiver in accordance with Embodiment 6 of the present invention is constructed in such a way as to display the status of the acquisition of program information by using a remote control button number, the digital broadcast receiver enables the user to grasp the status of the acquisition of program information for each of broadcast stations registered into remote control button numbers.

The digital broadcast receiver in accordance with above-mentioned Embodiment 6 is constructed in such a way as to, in order to show the status of the acquisition of program information, display a corresponding remote control button number and a corresponding acquisition status. Furthermore, the digital broadcast receiver can be constructed in such a way as to display a corresponding broadcast station name as well.

### Embodiment 7

A digital broadcast receiver in accordance with Embodiment 7 of the present invention has the same functional structure as the digital broadcast receiver in accordance with Embodiment 1 shown in FIG. 1.

The digital broadcast receiver in accordance with this Embodiment 7 operates in the same way that the digital broadcast receiver in accordance with Embodiment 5 operates, except for the following point. That is, the digital broadcast receiver in accordance with Embodiment 7 shows the status of the acquisition of program information (refer to FIG. 15), the progress of the download of a frequency list (refer to FIG. 16), and the status of the monitoring of relay stations and affiliated stations (refer to FIG. 17), which are provided by the digital broadcast receiver in accordance with Embodiment 5, by using coloring.

FIG. 20 shows a conceptual screen display which is produced by the digital broadcast receiver in accordance with Embodiment 7 when the digital broadcast receiver is acquiring the program information, and shows an image of mountains which is a slightly-reduced program video image of “16:9”. A character string enclosed by each of rounded rectangles arranged on a left side of the image and running in a vertical direction shows the status of the acquisition of the corresponding program information. The color of each of the rounded rectangles means the acquisition status (blue means that the program information has been acquired, yellow means that the program information is being acquired, and pink means that the program information has not been acquired yet).

FIG. 21 shows a conceptual screen display which is produced by the digital broadcast receiver in accordance with Embodiment 7 when the digital broadcast receiver is downloading the frequency list, and shows an image of mountains which is a slightly-reduced program video image of “16:9”. The color of a rectangle arranged in a lower margin under the image shows the implementation status of the download of the frequency list (pink shows 0<=progress ratio<25%, yellow shows 25%<=progress ratio<50%, green shows 50%<=progress ratio<75%, and blue shows 75%<=progress ratio<=100%).

FIG. 22 shows a conceptual screen display which is produced by the digital broadcast receiver in accordance with Embodiment 7 when the digital broadcast receiver is monitoring relay stations and affiliated stations, and shows an image of mountains which is a slightly-reduced program video image of “16:9”. The color of each of rounded rectangles arranged in a margin portion on a right side of the image and running in a vertical direction shows the implementation status of a corresponding one of the monitored repeater and affiliated stations (blue shows that the reception status is very good, green shows that the reception status is good, yellow shows that the reception status is acceptable, pink shows that the reception status is not acceptable, white shows that the status of the monitoring is being received, and gray shows that the status of the monitoring has not been received).

As previously explained, because the digital broadcast receiver in accordance with Embodiment 7 of the present invention is constructed in such a way as to display the collection status of broadcast information by using coloring, the digital broadcast receiver enables the user to grasp the collection status at a glance.

The digital broadcast receiver in accordance with above-mentioned Embodiment 7 is constructed in such a way as to express the progress of the download of the frequency list by using characters and a color. As an alternative, the digital broadcast receiver can be constructed in such a way as to show the progress of the download of the frequency list by using a combination of a graphic and a color, like a progress bar. For example, by coloring the progress bar in pink when 0<=progress ratio<25%, in yellow when 25%<=progress ratio<50%, in green when 50%<=progress ratio<75%, or in blue when 75%<=progress ratio<=100%, the digital broadcast receiver enables the user to grasp the progress of the download of the frequency list more easily from both the length and color of the progress bar.

Furthermore, the digital broadcast receiver in accordance with Embodiment 7 does not describe the meaning of each of the different colors in the conceptual screen display, though the digital broadcast receiver can be alternatively constructed in such a way as to add an explanation showing the meaning of each of the different colors to a margin portion on a side of the program video image, or the like. According to this structure, the collection status of broadcast information can be easily understood.

### Embodiment 8

A digital broadcast receiver in accordance with Embodiment 8 of the present invention has the same functional structure as the digital broadcast receiver in accordance with Embodiment 1 shown in FIG. 1.

The digital broadcast receiver in accordance with this Embodiment 8 operates in the same way that the digital broadcast receiver in accordance with Embodiment 2 operates, except for the following point. That is, the digital broadcast receiver in accordance with Embodiment 8 shows the status of the acquisition of program information (refer to FIG. 3), and the status of the monitoring of relay stations and affiliated stations (refer to FIG. 8), which are provided by the digital broadcast receiver in accordance with Embodiment 2, by using graphics instead of broadcast station logos.

FIG. 23 shows a conceptual screen display which is produced by the digital broadcast receiver in accordance with Embodiment 8 when the digital broadcast receiver is acquiring the program information, and shows an image of mountains which is a slightly-reduced program video image of “16:9”. A content enclosed by each of rounded rectangles arranged on a left side of the image and running in a vertical direction shows the status of the acquisition of the corresponding program information. A graphic within square brackets in a lower part of each of rounded rectangles shows the acquisition status (◯ shows that the program information has been acquired, Δ shows that the program information is being acquired, and X shows that the program information has not been acquired yet).

FIG. 24 shows a conceptual screen display which is produced by the digital broadcast receiver in accordance with Embodiment 8 when the digital broadcast receiver is monitoring relay stations and affiliated stations, and shows an image of mountains which is a slightly-reduced program video image of “16:9”. A graphic within square brackets in a lower part of each of rounded rectangles arranged in a margin portion on a right side of the image and running in a vertical direction shows the implementation status of a corresponding one of the monitored repeater and affiliated stations (⊚ shows that the reception status is very good, ◯ shows that the reception status is good, Δ shows that the reception status is acceptable, X shows that the reception status is not acceptable, + shows that the status of the monitoring is being received, and − shows that the status of the monitoring has not been received yet).

As previously explained, because the digital broadcast receiver in accordance with Embodiment 8 of the present invention is constructed in such a way as to display the collection status of broadcast information by using graphics, the digital broadcast receiver enables the user to grasp the collection status at a glance.

The digital broadcast receiver in accordance with above-mentioned Embodiment 8 is constructed in such a way as to express the progress of the download of broadcast information by using characters and graphics. Furthermore, the digital broadcast receiver can be constructed in such a way as to express the progress of the download of the frequency list by further combining a color with each set of characters and a graphic. In addition, the digital broadcast receiver in accordance with Embodiment 8 does not describe the meaning of each of the different graphics in the conceptual screen display, though the digital broadcast receiver can be alternatively constructed in such a way as to add an explanation showing the meaning of each of the different graphics to a margin portion on a side of the program video image, or the like. According to this structure, the collection status of broadcast information can be easily understood.

### Embodiment 9

A digital broadcast receiver in accordance with Embodiment 9 of the present invention is constructed in such a way as to, when the reception status of a broadcast station gets worse and the broadcast information cannot be collected, display that the reception status gets worse and the broadcast information cannot be collected. The digital broadcast receiver in accordance with Embodiment 8 of the present invention has the same functional structure as the digital broadcast receiver in accordance with Embodiment 1 shown in FIG. 1.

The digital broadcast receiver in accordance with this Embodiment 9 operates in the same way that the digital broadcast receiver in accordance with Embodiment 2 operates as shown in the flow chart of FIG. 6, except for the following point. Hereafter, the operation of the digital broadcast receiver in accordance with this embodiment will be explained with reference to the flowchart shown in FIG. 6, focusing on a point different from that of the digital broadcast receiver in accordance with Embodiment 2.

In step ST4 of the broadcast information collection status display process shown in the flow chart of FIG. 6, a display control unit 11 acquires the implementation status of the acquisition of the program information from a collection status generation unit 19, like in the case of the digital broadcast receiver in accordance with Embodiment 2. In this case, it is assumed that the display control unit 11 acquires an acquisition failure notification showing that the digital broadcast receiver has failed in the acquisition of the program information of MHK Educational TV, unlike in the case of the digital broadcast receiver in accordance with Embodiment 2.

The display control unit 11 then, in step ST5, draws an image showing the implementation status of the acquisition of the program information in an OSD plane. Through these processes, a conceptual screen display as shown in FIG. 25 is produced, and a character string showing that the acquisition of the program information cannot be acquired is displayed for MHK Educational TV.

The conceptual screen display shown in FIG. 25 is produced by the digital broadcast receiver in accordance with Embodiment 9 when the digital broadcast receiver is acquiring the program information, and each of rounded rectangles arranged in a left end portion of the screen and running in a vertical direction shows the status of the acquisition of the corresponding program information. The second rounded rectangle from the top displays that the reception status of MHK Education TV is bad, and therefore the program information cannot be acquired.

It is further assumed that in step ST9 of the broadcast information collection status display process shown in the flow chart of FIG. 6, the display control unit 11 tries to acquire the ratio of an already-acquired part of the frequency list from the collection status generation unit 19, but acquires a reception failure notification showing that the reception status is bad and the digital broadcast receiver has failed in the download of a frequency list.

The display control unit 11 then, in step ST10, draws the following character string: “Frequency list cannot be downloaded because reception status is bad” in the OSD plane as the implementation status of the download. Through these processes, a conceptual screen display as shown in FIG. 26 is produced.

The conceptual screen display shown in FIG. 26 is produced by the digital broadcast receiver in accordance with Embodiment 9 when the digital broadcast receiver is downloading the frequency list, and a character string in a rectangle in a lower end portion of the screen shows the implementation status of the download. In the digital broadcast receiver in accordance with this Embodiment 9, the character string shows that the frequency list cannot be downloaded because the reception status of the broadcast station which is the target for the channel selection is bad.

Furthermore, in step ST11 of the broadcast information collection status display process shown in the flow chart of FIG. 6, the display control unit 11 acquires the implementation status of the monitoring of relay stations and affiliated stations from the collection status generation unit 19, like in the case of the digital broadcast receiver in accordance with Embodiment 2. In this case, it is assumed that because the reception status of MHK General TV (Kyoto) which is an affiliated station is bad, the display control unit 11 acquires a failure notification showing that the digital broadcast receiver has failed in the reception, unlike the digital broadcast receiver in accordance with Embodiment 2.

The display control unit 11 then, in step ST12, draws an image showing the implementation status of the monitoring of relay stations and affiliated station in the OSD plane. Through these processes, a conceptual screen display as shown in FIG. 27 is produced, and a character string showing that the broadcast cannot be received is displayed for MHK General TV (Kyoto).

The conceptual screen display shown in FIG. 27 is produced by the digital broadcast receiver in accordance with Embodiment 9 when the digital broadcast receiver is monitoring relay stations and affiliated stations, and a character string in each of rounded rectangles arranged in a right end portion of the screen and running in a vertical direction shows the implementation status of the monitoring of a corresponding one of relay stations and affiliated stations. In the digital broadcast receiver in accordance with this Embodiment 9, the character string in the rounded rectangle showing MHK General TV (Kyoto), which is an affiliated station, shows that because the reception status is bad, the broadcast cannot be received.

As previously explained, because the digital broadcast receiver in accordance with Embodiment 9 of the present invention is constructed in such a way as to, when broadcast information cannot be collected from a broadcast station because the reception status gets worse, for example, produce a screen display showing that the broadcast information cannot be collected, the digital broadcast receiver enables the user to easily grasp that the broadcast information cannot be collected.

The digital broadcast receiver in accordance with above-mentioned Embodiment 9 is constructed in such a way as to display that broadcast information cannot be collected by using characters. As an alternative, the digital broadcast receiver can be constructed in such a way as to display that broadcast information cannot be collected by using a broadcast station logo, a remote control button number, a color, or a graphic.

Furthermore, the digital broadcast receiver in accordance with above-mentioned Embodiment 9 can be constructed in such a way as to, instead of displaying that broadcast information cannot be collected, in this situation, turn off the display of the collection status of the broadcast information and then switch to a full-screen display of only the program video image.

In addition, the digital broadcast receiver in accordance with above-mentioned Embodiment 9 is constructed in such a way as to, when the reception status of the broadcast station which has been set, as the target for channel selection, by a broadcast information collection unit 14 gets worse, display that the broadcast information cannot be collected. As an alternative, the digital broadcast receiver can be constructed in such a way as that when the reception status of the broadcast of the broadcast station currently being reproduced by a broadcast reception and reproduction unit 1 gets worse, the broadcast reception and reproduction unit 1 and the broadcast information collection unit 14 receive the broadcast of the same broadcast station and the digital broadcast receiver carries out diversity combining of both the received signals, thereby improving the receiving sensitivity. Also in this case, the digital broadcast receiver can be constructed in such a way as to display that the broadcast information cannot be collected.

Although the diversity combining is used by conventional vehicle-mounted digital television receivers and is a well-known technology, an explanation of the diversity combining will be made briefly. In the diversity combining, a frequency analysis of each of digital broadcast waves received by a plurality of antennas is conducted, the amplitude levels of a number of carrier waves included in each of the digital broadcast waves are calculated, a weight is adjusted for each of the carrier waves in such a way that the C/N ratio of the combined broadcast waves is maximized, and the digital broadcast waves are received while they are synchronized with one another on a per-carrier-wave basis.

In the digital broadcast receiver in accordance with Embodiment 1 shown in FIG. 1, the diversity combining can be implemented by changing the function of each of the components as follows. That is, a control unit 21 commands the broadcast information collection unit 14 to carry out the diversity combining. The broadcast information collection unit 14 switches the destination of the output of a second digital demodulation unit 16 from a second information demultiplex unit 17 to a first digital demodulation unit 3. The first digital demodulation unit 3 combines the digital broadcast wave received by a first antenna 2 and that received by a second antenna 15.

### Embodiment 10

A digital broadcast receiver in accordance with Embodiment 10 of the present invention is constructed in such a way as to display buttons as images each showing the collection status of broadcast information to enable a user to select one of the buttons through the user's operation on the digital broadcast receiver, and enable the user to select a button showing the collection status of broadcast information to display a program list of another station or select an program video image provided by a relay station or an affiliated station.

The digital broadcast receiver in accordance with Embodiment 2 of the present invention has the same functional structure as the digital broadcast receiver in accordance with Embodiment 1 shown in FIG. 1.

Next, the operation of the digital broadcast receiver in accordance with Embodiment 10 will be explained with reference to a flow chart shown in FIG. 28, focusing on a user interface (UI) process which the digital broadcast receiver performs while displaying the collection status of broadcast information. In the flow chart shown in FIG. 28, steps which are the same as those in the broadcast information collection status display process carried out by the digital broadcast receiver in accordance with Embodiment 2 shown in the flow chart of FIG. 6 or like steps are designated by the same reference characters as those used in FIG. 6, and the explanation of the steps will be simplified hereafter.

In the UI process which is performed while the collection status of broadcast information is being displayed, the broadcast information currently being collected is checked to see first (step ST3). More specifically, a display control unit 11 acquires the broadcast information currently being collected from a collection status generation unit 19, and, when the program information is being acquired, advances to step ST18, when broadcast information is being downloaded, advances to step ST21, or, when relay stations and affiliated stations are being monitored, advances to step ST22.

In step ST18, a screen display showing that the program information is being acquired (refer to FIG. 29) is produced. Although the process of this step ST18 is substantially the same as the processes of steps ST4, ST5, ST7, and ST8 of the broadcast information collection status display process shown in the flow chart of FIG. 6, the process of step ST18 differs from those of the digital broadcast receiver in accordance with Embodiment 2 in that rounded rectangles arranged in a left end portion of the screen and running in a vertical direction are selectable buttons.

An implicit selection button is then initialized (step ST19). More specifically, when the screen display is produced first, initialization of a selection button which is selected implicitly (in the screen display shown in FIG. 29, the third button from the top) is carried out.

The selection button is then focused (step ST20). More specifically, in the screen display example shown in FIG. 29, the background color of the third button from the top is filled in yellow, and the outer frame of the rounded rectangle of the third button is expressed as a heavy line. After that, the digital broadcast receiver advances the sequence to step ST25.

In step ST21, because selectable buttons do not have to be displayed, a screen display showing that broadcast information is being downloaded is produced. More specifically, the same processes as those of steps ST9, ST10, ST7, and ST8 of the broadcast information collection status display process shown in the flow chart of FIG. 6 are carried out, a screen display similar to the conceptual screen display shown in FIG. 7 is produced. After that, the digital broadcast receiver advances the sequence to step ST25.

In step ST22, a screen display showing that relay stations and affiliated stations are being monitored (refer to FIG. 30) is produced. Although the process of this step ST22 is substantially the same as the processes of steps ST11, ST12, ST7, and ST8 of the broadcast information collection status display process shown in the flow chart of FIG. 6, the process of step ST22 differs from those of the digital broadcast receiver in accordance with Embodiment 2 in that rounded rectangles arranged in a right end portion of the screen and running in a vertical direction are selectable buttons.

An implicit selection button is then initialized (step ST23). More specifically, when the screen display is produced first, initialization of a selection button which is selected implicitly (in the screen display shown in FIG. 30, the second button from the top) is carried out.

The selection button is then focused (step ST24). More specifically, in the screen display example shown in FIG. 30, the background color of the second button from the top is filled in yellow, and the outer frame of the rounded rectangle of the third button is expressed as a heavy line. After that, the digital broadcast receiver advances the sequence to step ST25.

The acquisition of a UI event is tried in step ST25. More specifically, the display control unit 11 acquires a UI event associated with a user interface via a control unit 21. The UI event is propagated to from the task of the control unit 21 the task of the display control unit 11 by using a message communication mechanism for carrying out communications between the tasks. UI events include an input via a remote control manipulation and a switching command for switching to a process of collecting higher-priority broadcast information, the switching command being issued by the control unit 21. Remote control manipulations which are used as a user's operation which is done while the collection status of broadcast information is being displayed include only the following three manipulations: manipulations on up/down arrow buttons and an enter button for data broadcast. The other buttons for data broadcast except ‘d’ button (a return button, a 4-color (blue, red, green, and yellow) button, and left/right arrow buttons) are not used.

It is then checked to see whether or not there is a UI event (step ST26). When it is determined in this step ST26 that there is no UI event, a process of waiting for a fixed time interval is carried out (step ST27). Then, the digital broadcast receiver returns the sequence to step ST25.

When it is determined in above-mentioned step ST26 that there is a UI event, the type of the UI event is then checked to see (step ST28). When it is determined in this step ST28 that the type of the UI event is an issue of the switching command for switching to a process of collecting higher-priority broadcast information, the digital broadcast receiver returns the sequence to step ST3 and repeats the above-mentioned processes.

When it is determined in above-mentioned step ST28 that the type of the UI event is a pushdown of the up or down arrow button for data broadcast of the remote control, the selection button is updated in such a way that a button just above or below the selection button is then selected as a new selection button (step ST29). More specifically, when the type of the UI event is a pushdown of the up arrow button, the selection button is updated in such a way that a button just above the selection button is selected as a new selection button, whereas when the type of the UI event is a pushdown of the down arrow button, the selection button is updated in such a way that a button just below the selection button is selected as a new selection button.

The selection button is then focused (step ST30). More specifically, the screen display is updated to a screen display in which the newly selected selection button is focused. After that, the digital broadcast receiver returns the sequence to step ST25 and then repeats the above-mentioned processes. Through the processes of above-mentioned steps ST29 and ST30, the selection button moves upwardly and downwardly according to the user's operation on the up and down arrow buttons.

When it is determined in above-mentioned step ST28 that the type of the UI event is a pushdown of the return button, the 4-color button, the left arrow button, or the right arrow button for data broadcast of the remote control, the digital broadcast receiver returns the sequence to step ST25 and then repeats the above-mentioned processes.

When it is determined in above-mentioned step ST28 that the type of UI event is a pushdown of another button of the remote control, the digital broadcast receiver advances to step ST31 in order to carry out a typical television operation. The display control unit 11, in step ST31, carries out a process, such as a process of producing a data broadcast screen display, or a channel switching, according to the other button which has been pushed down. This process is the same as that carried out by a digital broadcast receiver for home use. After that, the digital broadcast receiver advances the sequence to step ST34.

When it is determined in above-mentioned step ST28 that the type of the UI event is a pushdown of the enter button for data broadcast of the remote control, the digital broadcast receiver advances the sequence to step ST3′. In step ST3′, the broadcast information currently being collected is checked to see, like in the process of step ST3, and, when the program information is being acquired, the digital broadcast receiver advances to step ST32, or when relay and affiliated stations are being monitored, the digital broadcast receiver advances to step ST33.

In step ST32, the program list of the broadcast station currently being selected is displayed. More specifically, the display control unit 11 acquires the program information of the broadcast station corresponding to the selection button from an information storage unit 18, and produces a program list screen display. In the screen display example shown in FIG. 29, the program list of “◯◯ broadcast” is displayed. After that, the digital broadcast receiver advances the sequence to step ST34.

The program list has display styles including a display style in which only the program list of one broadcast station is displayed, and a display style in which the program lists of a plurality of broadcast stations are displayed collectively (in the same form as a TV program listing page on a newspaper). In the latter display style, the program lists of a plurality of broadcast stations can be displayed in such a way that the program list of the broadcast station corresponding to the selection button is placed at the center of all the program lists.

In step ST33, a program video image of the selected one of the relay stations and affiliated stations is displayed. More specifically, the display control unit 11 switches to a program video image of the one of the relay stations and affiliated stations corresponding to the selection button. In a screen display example shown in FIG. 30, “MHK General TV (Hyogo)” which is an affiliated station is selected, and a program video image of MHK General TV (Hyogo) is displayed. After that, the digital broadcast receiver advances the sequence to step ST34.

In step ST34, the display control unit 11 switches the screen display to be outputted to the display output unit 12 from the screen display showing the collection status to the screen display produced in step ST31, ST32, or ST33. As a result, the screen display showing the collection status is switched to a non-display state while the screen display produced in step ST31, ST32, or ST33 is switched to a display state. After performing the above-mentioned processes, the digital broadcast receiver ends the UI process while displaying the collection status of the broadcast information.

FIG. 29 shows a conceptual screen display which is produced by the digital broadcast receiver in accordance with Embodiment 10 when the digital broadcast receiver is acquiring the program information, and rounded rectangles arranged in a left end portion of the screen and running in a vertical direction are selectable buttons and a character string in each of the rounded rectangles shows the status of the acquisition of the corresponding program information. The third rounded rectangle from the top is the button currently being selected by the user, and the yellow background color and the outer frame that is a heavy line show that this button is focused.

FIG. 30 shows a conceptual screen display which is produced by the digital broadcast receiver in accordance with Embodiment 10 when the digital broadcast receiver is monitoring relay stations and affiliated stations, and rounded rectangles arranged in a right end portion of the screen and running in a vertical direction are selectable buttons and a character string in each of the rounded rectangles shows the implementation status of the monitoring of a corresponding one of relay stations and affiliated stations. The second rounded rectangle from the top is the button currently being selected by the user, and the yellow background color and the outer frame that is a heavy line show that this button is focused.

As previously explained, when the user pushes down an execution button while selecting a specific rounded rectangle button by using a remote control or the like, the digital broadcast receiver in accordance with Embodiment 10 of the present invention can display the program list of the broadcast station corresponding to the specific rounded rectangle button. Therefore, the operativity of the digital broadcast receiver can be improved as compared with a case in which the user opens a menu to select a broadcast station and display the program list of the broadcast station.

The digital broadcast receiver in accordance with above-mentioned Embodiment 10 is constructed in such a way as to enable the user to operate the digital broadcast receiver by using the following three buttons: the enter button and the up/down arrow buttons among the buttons for data broadcast. As an alternative, the digital broadcast receiver can be constructed in such a way as to arrange the on-screen rounded rectangle buttons in a horizontal direction to enable the user to operate the digital broadcast receiver by using the enter button and the left/right arrow buttons. The digital broadcast receiver alternatively enables the user to implement the operation by using other buttons.

Furthermore, the digital broadcast receiver in accordance with Embodiment 10 is constructed in such a way as to disable the user to operate the digital broadcast receiver while broadcast information is being downloaded. As an alternative, the digital broadcast receiver can be constructed in such a way as to additionally provide a button in the vicinity of a progress bar showing the download of the broadcast information, and, when the user pushes down this button, display detailed information about the broadcast information currently being downloaded (including a frequency list, receiver software, or genre information).

### Embodiment 11

A digital broadcast receiver in accordance with Embodiment 11 of the present invention has a function of, every time when a user performs an operation of selecting a button showing the collection status of broadcast information, reading aloud the broadcast station name corresponding to the selected button, and, after displaying the program list of the broadcast station, reading aloud the program list, in addition to the functions of the digital broadcast receiver in accordance with Embodiment 10.

FIG. 31 is a block diagram showing the functional structure of the digital broadcast receiver in accordance with Embodiment 11. In this digital broadcast receiver, a voice synthesis processing unit 22 is added to the digital broadcast receiver in accordance with Embodiment 1 shown in FIG. 1. The same components as those of the digital broadcast receiver in accordance with Embodiment 1 shown in FIG. 1 or like components are designated by the same reference numerals as those used in FIG. 1, the explanation of the components will be omitted hereafter.

The voice synthesis processing unit 22 synthesizes a voice according to a read character string acquired from an information storage unit 18, and sends the voice to an audio control unit 8 of an output control unit 7. Because the voice synthesis process is based on a well-known technology, the explanation of the details of the voice synthesis process will be omitted hereafter.

The digital broadcast receiver in accordance with this Embodiment 11 operates in the same way that the digital broadcast receiver in accordance with Embodiment 10 operates as shown in the flowchart of FIG. 28, except for the following point. Hereafter, the operation of the digital broadcast receiver in accordance with this embodiment will be explained with reference to the flow chart shown in FIG. 28, focusing on the point different from that of the digital broadcast receiver in accordance with Embodiment 10.

First, a read aloud of a broadcast station name which is caused by a movement of a selection button will be explained. When the selection button moves upwardly or downwardly and a focus display of the selection button is also moved in synchronization with the movement of the selection button through processes of steps ST29 and ST30 of the flowchart shown in FIG. 28, a display control unit 11 commands the information storage unit 18 to synthesize a voice of “the broadcast station name” corresponding to the selection button. The information storage unit 18 creates a character string showing the reading of the broadcast station name corresponding to the selection button according to this command, and sends the character string to the voice synthesis processing unit 22.

The voice synthesis processing unit 22 synthesizes a voice of “the broadcast station name” according to the read character string sent thereto from the information storage unit 18, and sends the voice to the audio control unit 8. The audio control unit 8 stops the output of the program audio temporarily, sends the synthesized voice of “the broadcast station name” sent thereto from the voice synthesis processing unit 22 to an audio output unit 9 to make this audio output unit output the synthesized voice from a speaker 10 and, when the audio output unit has completed the output of the broadcast station name, returns to the output of the program audio.

Next, a read aloud of a program list will be explained. In step ST32 of the flow chart shown in FIG. 28, the display control unit 11 displays the program list of the broadcast station corresponding to the selection button, and also commands the information storage unit 18 to synthesize a voice of “the contents of the on-screen program list”. The information storage unit 18 creates a read character string showing the contents of the on-screen program list according to this command, and sends the read character string to the voice synthesis processing unit 22. The voice synthesis processing unit 22 synthesizes a voice of “the contents of the program list” according to the read character string sent thereto, and sends the voice to the audio control unit 8. The audio control unit 8 stops the output of the program audio temporarily, sends the synthesized voice of “the contents of the program list” sent thereto from the voice synthesis processing unit 22 to the audio output unit 9 to make this audio output unit output the synthesized voice from the speaker 10 and, when the audio output unit has completed the output of the contents of the program list, returns to the output of the program audio.

As previously explained, when the user pushes down an execution button while selecting a specific rounded rectangle button by using a remote control or the like, the digital broadcast receiver in accordance with Embodiment 11 of the present invention can read aloud the contents of the program list of the broadcast station corresponding to the specific rounded rectangle button. Therefore, the digital broadcast receiver enables the user to grasp the contents of the program list without having to see the display. Furthermore, because when the user moves the rounded rectangle button which he or she selects by using the up/down arrow buttons of the remote control, the digital broadcast receiver reads aloud the broadcast station name corresponding to the selected rounded rectangle button, the digital broadcast receiver enables the user to grasp which broadcast station is selected without having to see the display.

The digital broadcast receiver in accordance with above-mentioned Embodiment 11 is constructed in such a way as to stop the output of the program audio while reading aloud a broadcast station name or the contents of a program list. As an alternative, the digital broadcast receiver can be constructed in such a way as to reduce the audio volume of the program audio temporarily, or superimpose the synthesized voice output onto the program audio.

Furthermore, the digital broadcast receiver in accordance with Embodiment 11 is constructed in such a way as to disable the user to operate the digital broadcast receiver while downloading broadcast information. As an alternative, the digital broadcast receiver can be constructed in such a way as to additionally provide a button in the vicinity of a progress bar showing the download of the broadcast information, and, when the user pushes down this button, read aloud the implementation status of the download of the broadcast information.

### INDUSTRIAL APPLICABILITY

The digital broadcast receiver in accordance with the present invention enables the user to easily grasp whether the digital broadcast receiver has completed the collection of broadcast information while ensuring the visibility of a program video image. For example, the digital broadcast receiver can reduce the frequency with which the user feels burdensome to wait for a display of a program list after commanding the digital broadcast receiver to display the program list. Therefore, the digital broadcast receiver in accordance with the present invention is suitable for use as a digital broadcast receiver that receives a digital broadcast. More particularly, the digital broadcast receiver in accordance with the present invention is suitable for use as a digital broadcast receiver that displays the status of the acquisition of broadcast information in parallel with a display of an broadcast program.

1.-18. (canceled)

19. A digital broadcast receiver comprising:
a broadcast reception and reproduction unit for reproducing a program video image included in a received broadcast;
a broadcast information collection unit for collecting plural types of broadcast information included in a broadcast provided by a broadcast station different from a broadcast station providing the broadcast received by said broadcast reception and reproduction unit in parallel with the reproduction of the program video image by said broadcast reception and reproduction unit;
a collection status generation unit for generating a collection status of broadcast information collected by said broadcast information collection unit; and
an output control unit for displaying both the program video image reproduced by said broadcast reception and reproduction unit and the collection status of the broadcast information generated by said collection status generation unit, and for changing displayed information about the collection status of the broadcast information according to the type of the broadcast information collected by said broadcast information collection unit.

20. The digital broadcast receiver according to claim 19, wherein the output control unit displays the collection status of the broadcast information at a position where the displayed collection status does not overlap the program video image.

21. The digital broadcast receiver according to claim 20, wherein the output control unit reduces the program video image to form a blank part in a screen display and then displays the collection status of the broadcast information in said blank part.

22. The digital broadcast receiver according to claim 20, wherein the output control unit displays the collection status of the broadcast information in a left-side blank part or a right-side blank part which is created when the program video image originally having a height-to-width ratio of “4:3” is displayed at a height-to-width ratio of “16:9”.

23. The digital broadcast receiver according to claim 20, wherein the output control unit displays the collection status of the broadcast information in a left-side blank part or a right-side blank part when the program video image has a height-to-width ratio of “4:3”, and displays the collection status of the broadcast information in a blank part which is created by a reduction and a display of the program video image when the program video image has a height-to-width ratio of “16:9”.

24. The digital broadcast receiver according to claim 19, wherein the output control unit superimposes the collection status of the broadcast information onto the program video image to display the collection status of the broadcast information.

25. The digital broadcast receiver according to claim 24, wherein when displaying a subtitle or superimposed characters, the output control unit displays the collection status of the broadcast information at a position which the collection status does not overlap the subtitle or superimposed characters.

26. The digital broadcast receiver according to claim 19, wherein the output control unit displays the collection status of the broadcast information by using a broadcast station logo.

27. The digital broadcast receiver according to claim 19, wherein the output control unit displays the collection status of the broadcast information by using characters.

28. The digital broadcast receiver according to claim 19, wherein the output control unit displays the collection status of the broadcast information by using a remote control button number.

29. The digital broadcast receiver according to claim 19, wherein the output control unit displays the collection status of the broadcast information by using a color.

30. The digital broadcast receiver according to claim 19, wherein the output control unit displays the collection status of the broadcast information by using a graphic.

31. The digital broadcast receiver according to claim 19, wherein the output control unit displays the collection status of the broadcast information while bringing the collection status into correspondence with a broadcast station name.

32. The digital broadcast receiver according to claim 19, wherein when the broadcast information collection unit cannot collect the broadcast information, the collection status generation unit outputs information showing that the broadcast information cannot be collected, and the output control unit produces a display showing that the broadcast information cannot be collected according to the information outputted by said collection status generation unit.

33. The digital broadcast receiver according to claim 19, wherein said digital broadcast receiver has an operation input unit for inputting operation information, and the output control unit selects information to be displayed about the collection status of the broadcast information according to the operation information from said operation input unit and displays broadcast information corresponding to said selected information to be displayed.

34. The digital broadcast receiver according to claim 33, wherein said digital broadcast receiver has a voice synthesis processing unit for converting character information into voice information, and the output control unit outputs, by voice, voice information into which either the collection status of the broadcast information or the collected broadcast information is converted by said voice synthesis processing unit.

35. The digital broadcast receiver according to claim 19, wherein the output control unit displays the collection status of the broadcast information in a non-video image form.
